(19) United States
(12) Patent Application Publication
(10) Pub. No.: US 2018/0322246 A1
(43) Pub. Date: Nov. 8, 2018

(54) SYSTEM AND METHOD FOR SECURE, HIGH-SPEED TRANSFER OF VERY LARGE FILES

(71) Applicant: ANNAI SYSTEMS, INC., Carlsbad, CA (US)

(72) Inventors: Lawrence Ganeshalingam, Laguna Beach, CA (US); Patrick Allen, Scotts Valley, CA (US)

(21) Appl. No.: 15/587,305

(22) Filed: May 4, 2017

(51) Int. Cl. G06F 19/28; G06F 21/62; H04L 29/06; H04L 29/08

(52) U.S. Cl. CPC G06F 19/28; G06F 21/6218; H04L 63/061; H04L 67/108; H04L 67/104; H04L 67/1063; H04L 67/06

(57) ABSTRACT

A method for parallelized transfer of an electronic file over a network. The method includes sending a first portion of the electronic file from a first sending node and receiving, at the first sending node, information relating to a second portion of the electronic file sent by a second sending node. The method further includes sending a third portion of the electronic file from the first sending node, wherein the third portion is different from the second portion.

### CROSS-REFERENCE TO RELATED APPLICATIONS

The present application is a continuation of U.S. application Ser. No. 13/417,188, entitled BIOLOGICAL DATA NETWORKS AND METHODS THEREFOR, filed on Mar. 9, 2012, which claims the benefit of priority under 35 U.S.C. § 119(e) of U.S. Provisional Patent Application Ser. No. 61/451,086, entitled BIOLOGICAL DATA NETWORK, filed on Mar. 9, 2011, of U.S. Provisional Patent Application Ser. No. 61/539,942, entitled SYSTEM AND METHOD FOR SECURE, HIGHSPEED TRANSFER OF VERY LARGE FILES, filed Sep. 27, 2011, and of U.S. Provisional Patent Application Ser. No. 61/539,931, entitled SYSTEM AND METHOD FOR FACILITATING NETWORK-BASED TRANSACTIONS INVOLVING SEQUENCE DATA, filed Sep. 27, 2011, the content of each of which is hereby incorporated by reference herein in its entirety for all purposes. This application is related to U.S. Utility patent application Ser. No. 12/837,452, entitled METHODS AND SYSTEMS FOR PROCESSING GENOMIC DATA, filed on Jul. 15, 2010, which claims priority to U.S. Provisional Patent Application Ser. No. 61/358,854, entitled METHODS AND SYSTEMS FOR PROCESSING GENOMICS DATA, filed on Jun. 25, 2010, and to U.S. Utility patent application Ser. No. 12/828,234, entitled METHODS AND SYSTEMS FOR PROCESSING GENOMIC DATA, filed on Jun. 30, 2010, which claims priority to U.S. Provisional Patent Application Ser. No. 61/358,854, entitled METHODS AND SYSTEMS FOR PROCESSING GENOMICS DATA, filed on Jun. 25, 2010, the content of each of which is hereby incorporated by reference herein in its entirety for all purposes. This application is also related to U.S. Utility patent application Ser. No. 13/223,077, entitled METHODS AND SYSTEMS FOR PROCESSING POLYMERIC SEQUENCE DATA AND RELATED INFORMATION, filed on Aug. 31, 2011, and to U.S. Utility patent application Ser. No. 13/223,084, entitled METHODS AND SYSTEMS FOR PROCESSING POLYMERIC SEQUENCE DATA AND RELATED INFORMATION, filed on Aug. 31, 2011, and to U.S. Utility patent application Ser. No. 13/223,088, entitled METHODS AND SYSTEMS FOR PROCESSING POLYMERIC SEQUENCE DATA AND RELATED INFORMATION, filed on Aug. 31, 2011, and to U.S. Utility patent application Ser. No. 13/223,092, entitled METHODS AND SYSTEMS FOR PROCESSING POLYMERIC SEQUENCE DATA AND RELATED INFORMATION, filed on Aug. 31, 2011, and to U.S. Utility patent application Ser. No. 13/223,097, entitled METHODS AND SYSTEMS FOR PROCESSING POLYMERIC SEQUENCE DATA AND RELATED INFORMATION, filed on Aug. 31, 2011, the content of each of which is hereby incorporated by reference herein in its entirety for all purposes.

This application is also related to U.S. Utility patent application Ser. No. 13/417,184, entitled BIOLOGICAL DATA NETWORKS AND METHODS THEREFOR, filed on Mar. 9, 2012, and to U.S. Utility patent application Ser. No. 13/417,187, entitled BIOLOGICAL DATA NETWORKS AND METHODS THEREFOR, filed on Mar. 9, 2012, and to U.S. Utility patent application Ser. No. 13/417,189, entitled BIOLOGICAL DATA NETWORKS AND METHODS THEREFOR, filed on Mar. 9, 2012, and to U.S. Utility patent application Ser. No. 13/417,190, entitled BIOLOGICAL DATA NETWORKS AND METHODS THEREFOR, filed on Mar. 9, 2012, and to U.S. Utility patent application Ser. No. 13/417,192, entitled BIOLOGICAL DATA NETWORKS AND METHODS THEREFOR, filed on Mar. 9, 2012, and to U.S. Utility patent application Ser. No. 13/417,193, entitled BIOLOGICAL DATA NETWORKS AND METHODS THEREFOR, filed on Mar. 9, 2012, the disclosures of which are herein incorporated by reference in their entirety.

### DESCRIPTION OF THE TEXT FILE SUBMITTED ELECTRONICALLY

The contents of the text file submitted electronically herewith are incorporated herein by reference in their entirety: A computer readable format copy of the Sequence Listing (filename: ANNA_006_08US_SeqList_ST25.txt, date recorded: May 8, 2012, file size 1 kilobyte).

### FIELD

This application is generally directed to processing and networking polymeric sequence information, including biopolymeric sequence information such as DNA sequence information.

### BACKGROUND

Deoxyribonucleic acid (“DNA”) sequencing is the process of determining the ordering of nucleotide bases (adenine (A), guanine (G), cytosine (C) and thymine (T)) in molecular DNA. Knowledge of DNA sequences is invaluable in basic biological research as well as in numerous applied fields such as, but not limited to, medicine, health, agriculture, livestock, population genetics, social networking, biotechnology, forensic science, security, and other areas of biology and life sciences.

Sequencing has been done since the 1956s, when academic researchers began using laborious methods based on two-dimensional chromatography. Due to the initial difficulties in sequencing in the early 1956s, the cost and speed could be measured in scientist years per nucleotide base as researchers set out to sequence the first restriction endonuclease site containing just a handful of bases. Thirty years later, the entire 3.2 billion bases of the human genome have been sequenced, with a first complete draft of the human genome done at a cost of about three billion dollars. Since then sequencing costs have rapidly decreased.

Today, the cost of sequencing the human genome is on the order of $5000 and is expected to hit the $1000 mark later this year with the results available in hours, much like a routine blood test. As the cost of sequencing the human genome continues to plummet, the number of individuals having their DNA sequenced for medical, as well as other purposes, will likely increase significantly. Currently, the nucleotide base sequence data collected from DNA sequencing operations are stored in multiple different formats in a number of different databases.

Such databases also contain annotations and other attribute information related to the DNA sequence data including, for example, information concerning single nucleotide polymorphisms (SNPs), gene expression, copy number variations methylation sequence. Moreover, transcriptomic and proteomic data are also present in multiple formats in multiple databases. This renders it impractical to exchange and process the sources of genome sequence data and related information collected in various locations, thereby hampering the potential for scientific discoveries and advancements.

### SUMMARY

In one aspect the disclosure relates to a method of conveying biological sequence data. The method includes generating a data packet including a first header containing network routing information, a second header containing header information pertaining to the biological sequence data, and a payload containing a representation of the biological sequence data relative to a reference sequence. The method also includes storing the data packet in a queue in communication with a network interface. The method further includes transmitting the data packet over a network accessible through the network interface.

In another aspect the disclosure pertains to a method of receiving biological sequence data. The method includes receiving, through a network interface of a network node, a data packet including a first header containing network routing information, a second header containing header information pertaining to the biological sequence data, and a payload containing a compressed version of the biological sequence data. The method also includes providing the data packet to an input packet processor in communication with the network interface. At least the compressed version of the biological sequence data is then extracted from the data packet and stored within a memory of the network node.

In a further aspect the disclosure pertains to a network node including a network interface and a packet generator in communication with the network interface. The packet generator is configured to generate a data packet including a first header containing network routing information, a second header containing header information pertaining to the biological sequence data, and a payload containing a representation of the biological sequence data relative to a reference sequence. The network node further includes a queue in communication with the network interface, the data packet being stored within the queue. In addition, the network node includes a transmit controller for controlling transmission of the data packet over a network accessible through the network interface.

In yet another aspect the disclosure pertains to a network node including a network interface and an input packet processor in communication with the network interface. The input packet processor is configured to receive a data packet and extract at least a compressed version of biological sequence data from the data packet wherein the data packet includes a first header containing network routing information, a second header containing header information pertaining to the biological sequence data, and a payload containing the compressed version of the biological sequence data. The network node further includes a memory in which is stored the compressed version of the biological sequence data.

### BRIEF DESCRIPTION OF THE DRAWINGS

Various objects and advantages and a more complete understanding of the disclosure are apparent and more readily appreciated by reference to the following Detailed Description and to the appended claims when taken in conjunction with the accompanying Drawings wherein:

FIG. 1 is a representation is provided of a biological data unit comprised of a payload containing DNA sequence data (SEQ ID NO.: 2) and a BioIntelligence header containing information having biological relevance to the DNA sequence data (SEQ ID NO.: 2) within the payload.

FIG. 2 illustratively represents a biological data model which includes a plurality of interrelated layers.

FIG. 3 depicts a biological data unit having a BioIntelligence header and a payload containing an instruction-based representation of segmented DNA sequence data.

FIG. 4 is a logical flow diagram of a process for segmentation of biological sequence data and combining the segments with metadata attributes to form biological data units encapsulated with BioIntelligence headers.

FIG. 5 depicts a biological data network comprised of representations of biological data linked and interrelated by an overlay network containing a plurality of network nodes.

FIG. 6 illustrates an exemplary protocol stack implemented at a network node together with corresponding layers of the OSI network model.

FIG. 7 shows a high-level view of various data types that may be processed by a group of network nodes in response to a query/request received from a client terminal.

FIG. 8 provides a block diagrammatic representation of the architecture of an exemplary network node.

FIG. 9A illustratively represents a process effected by a network node to implement a sequence variants processing procedure.

FIG. 9B is a flowchart of an exemplary variants processing procedure.

FIG. 10 illustratively represents the processing occurring at a network node configured to perform a specialized processing function.

FIG. 11 provides a representation of an exemplary processing platform capable of being configured to implement a network node.

FIG. 12 illustrates one manner in which data may be processed, managed and stored at an individual network node in an exemplary clinical environment.

FIGS. 13-18 illustratively represent the manner in which information within the layered data structure is utilized at an individual network processing node.

FIG. 19 depicts a Smart Repository™ data repository configured to retrieve and aggregate genomic-related and other data relevant to the interests of actors interacting with the Smart Repository™ data repository.

FIG. 20 depicts a Smart Repository™ data repository which includes a SmartTracker™ data repository module and a transactor.

FIG. 21 illustrates an implementation of a Smart Repository™ data repository which includes a SmartTracker™ data repository module, a transactor and a transcriptor.

FIG. 22 is a flowchart representative of exemplary interaction between an actor and a Smart Repository™ data repository.

FIG. 23 illustrates an alternate implementation of a Smart Repository™ data repository including a GeneTransfer Executive module and a transcriptor.

FIG. 24 depicts an exemplary implementation of an actor configured to interact as a client with a Smart Repository™ data repository.

FIGS. 25A and FIG. 25B collectively provide a more detailed representation of exemplary process performed by a Smart Repository™ data repository in processing a request from an actor.

FIG. 26 is a flowchart representative of an exemplary process for ranking attributes appearing within relevant metadata files in order to identify a set of high-ranking attributes relative to a query and/or related query processing results.

FIG. 27 is a flowchart representative of an exemplary manner in which network nodes of a biological data network may cooperate to process a client request.

FIG. 28 is a flowchart representative of an exemplary sequence of operations involved in the identification and processing of sequence variants at a network node.

FIG. 29 is a flowchart representative of an exemplary sequence of operations carried out by network nodes of a biological data network in connection with processing of a disease-related query.

FIG. 30 is a flowchart representative of an exemplary sequence of operations involved in providing pharmacological response data in response to a user query concerning a specified disease.

FIG. 31 shows a flowchart representative of a manner in which information relating to various different layers of biologically-relevant data organized consistently with a biological data model may be processed at different network nodes.

### DETAILED DESCRIPTION

### Introduction

This disclosure relates generally to an innovative new biological data network and related methods capable of efficiently handling the massive quantities of DNA sequence data and related information expected to be produced as sequencing costs continue to decrease. The disclosed network and approaches permit such sequence data and related medical or other information to be efficiently stored in data containers provided at either a central location or distributed throughout a network, and facilitate the efficient network-based searching, transfer, processing, management and analysis of the stored information in a manner designed to meet the demands of specific applications.

The disclosed approaches permit such sequence data and any related medical, biological, referential or other information, be it computed, human-entered/directed or a combination thereof, to be efficiently transmitted and/or shared or otherwise conveyed from a centralized location or either partly or wholly distributed throughout the biological data network. These approaches also facilitate data formats and encodings used in the efficient processing, management and analysis of various “omics” (i.e., proto/onco/pharma) information. The innovative new biological data network or, equivalently, BioIntelligence network, is configured to operate with respect to biological data units stored at various network locations.

Each biological data unit will generally be comprised of one or more BioIntelligence headers associated with or relating to a payload containing a representation of segmented DNA sequence data or other non-sequential data of interest. The term header in this context refers to one or more pieces of information that have relevance to the payload, without regard to how or where such information is physically stored or represented within the BioIntelligence network. As is discussed below, it will be appreciated that certain operations performed by the nodes or elements of the biological data network may be effected with respect to the entirety of the biological data units undergoing processing; that is, with respect to representations of both the segmented sequence data and BioIntelligence headers of such biological data units.

However, the elements of the biological data network may perform other operations by, for example, comparing or correlating only the BioIntelligence headers of the biological data units being processed. In this way network bandwidth may be conserved by obviating the need for network transport of segmented biological sequence data, or some representation thereof, in connection with various processing operations involving biological units nominally stored at different network locations.

The biological data network may be comprised of a plurality of network nodes configured with processing and analytical capabilities, which are individually or collectively capable of responding to machine or user queries or requests for information. As is discussed below, the functionality of the new biological data network may be integrated into the current architectural framework of the Open Systems Interconnection (OSI) seven-layer model and the Transmission Control Protocol and Internet Protocol (TCP/IP) model for network and computing communications. This will allow service providers to configure existing network infrastructure to accommodate biological sequence data to deliver optimized quality of service for medical and health professionals practicing genomics-based personalized medicine. Alternatively or in addition, the new biological data network may be realized as an Internet-based overlay network capable of providing biological, medical and health-related intelligence to applications supported by the network.

The new biological data network facilitates overcoming the daunting challenges associated with analysis of various pertinent omics data types together with, and in the context of, all relevant, available prior knowledge. In this regard the new biological data network may facilitate development of an integrated ecosystem in which distributed databases are accessible on a network and in which the data stored therein is configured to be linked by BioIntelligence. This new biological data network may enable, for example, forming, securing, linking, searching, filtering, sorting, aggregating and connecting an individual's genome data with a layered data model of existing knowledge in order to facilitate extraction of new and meaningful information.

### Overview of Biological Data Units and BioIntelligence

As disclosed herein, the innovative new biological data network is configured to operate with respect to biological data units stored at various network locations. Biological data units can be considered as a set of information that is known or can be predicted to be associated with certain segments of genome sequences. Biological data units will generally be comprised of one or more BioIntelligence headers associated with or relating to a payload containing a representation of segmented DNA sequence data or other non-sequential data of interest.

The biological data units may be generated by dividing source DNA sequences into segments and associating one or more BioIntelligence headers (also referred to herein as “BI headers” or annotations or attributes) with one or more segments of genome sequence data. The various component parts XML metadata files that are of the header information contained in biological data units can be stored in distributed storage containers that are accessible on a network. Furthermore, the different segments of a whole genome sequence data contained in the payload of biological data units may be stored in multiple BAM files at various different locations on a network.

Each BI header can be considered a specific piece of information or set of information that may be associated with or have biological relevance to one or more specific segments of DNA sequence data within the payload of the biological data unit. It should be appreciated that any information that is relevant to the segmented sequence data payload of a biological data unit can be placed in the one or more BioIntelligence headers of the data unit or, as is discussed below, within BioIntelligence headers of other biological data units. It should also be clearly understood that the information contained in any biological data unit can be highly distributed and network linked in such a manner that allows filtration and dynamic recombination of any permutation of associated attributes and sequence segments.

The BioIntelligence headers may be arranged in any order, whether dependent upon or independent of the payload data. However, in one embodiment the BioIntelligence headers are each respectively associated with at least one layer of a biological data model of existing knowledge that is representative of the biological sequence data which, for example, may be stored as BAM files within the payloads of the distributed biological data units with which such headers or XML metadata attributes are associated.

Although the present disclosure provides specific examples of the use of BI headers in the context of a layered data model, it should be understood that BI headers may be realized in essentially any form capable of embedding information within, or associating such information with, all or part of any biological or other polymeric sequence or plurality thereof. For example, one or more BI headers could be associated with any permutation of segments of DNA sequence or other such polymeric sequence or within any combination thereof, in any analog or digital format.

The BI headers could also be placed within a representation of associated polymeric sequence data, or could be otherwise associated with any electronic file or other electronic structure representative of molecular information. In other words, the one or more metadata attributes that are stored in multiple storage containers on a network may compose BioIntelligence headers that are specifically associated with at least one segment of sequence contained in a file transfer session.

In the case in which BioIntelligence data is embedded within DNA or other biological sequence information, the BI headers or tags including the BioIntelligence data may be placed in front of, behind or in any arbitrary position within any particular segmented sequence data or multiple segmented data sequences. In other words, in one particular embodiment of the invention, information that is associated directly or indirectly may be stored within the base calls of reads that are contained in BAM files or any other sequence file format or internal memory structures, for example. This approach would involve a method for integrating, at least one specific attribute of information that is associated with a genome sequence between and or among the base calls contained within reads of sequence data files.

In addition, the BioIntelligence data may be embedded in a contiguous or disbursed manner among and within the base calls of the segmented sequence data. When this highly structured and layered approach is applied to the storage configuration of this sequence data and associated information it will advantageously facilitate the computationally efficient, effective and rapid analysis of, for example, the massive quantities of genome sequence data being generated by next-generation, high-throughput DNA sequencing machines.

In particular, distributed biological data units containing segmented DNA sequence data and associated attributes may be stored, sorted, filtered and operated on for various scope and depth of analysis based upon the said associated information which is contained within the BioIntelligence headers. This obviates the need to manipulate, transfer and otherwise breach the security of the segmented DNA sequence data in order to process and analyze such data.

One embodiment of the layered data model of the existing body of relevant knowledge includes not only BioIntelligence of or pertaining to biologically-relevant data but also other metadata which are associated with the nucleic acid sequence files. Such MetaIntelligence™ metadata may include, for example, facts, information, knowledge and prediction derived from biological, clinical, pharmacological, environmental, medical or other health-related data, including but not limited to other biological sequence data such as methylation sequence data as well as information on differential expression, alternative splicing, copy number variation and other related information.

The DNA sequence information included within the biological data units described herein may be obtained from a variety of sources. For example, DNA sequence information may be obtained “directly” from DNA sequencing apparatus, as well as from sequence data files that are stored in private and publicly accessible genome data repositories. Additionally, it may be computationally derived and/or manually gathered or inferred. In the case of the database of Genotypes and Phenotypes at the National Center for Biotechnology Information at the National Library of Medicine, the DNA sequence entries may be stored as BAM, SRF, fastq as well as in the FASTA format, which includes annotated information concerning the sequence data files. In one embodiment certain of the information contained within the one or more BioIntelligence headers of each biological data unit would be obtained from publicly accessible databases containing genome data sequences.

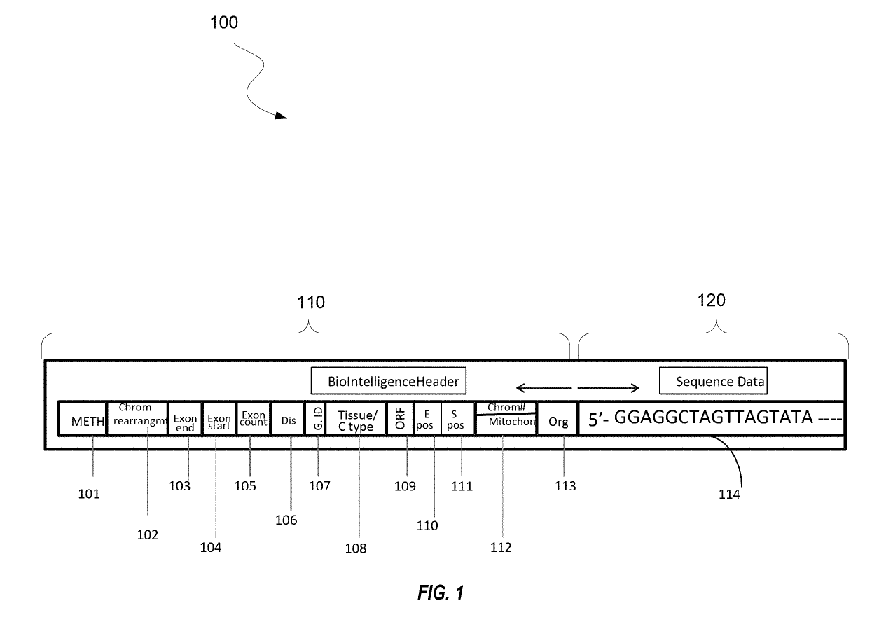

Turning now to FIG. 1, a representation is provided of a biological data unit comprised of a payload containing DNA sequence data and a BioIntelligence header containing information having biological relevance to the DNA sequence data within the payload. Furthermore, it should be appreciated that information contained in a particular BioIntelligence header may also point or associate with sequence data that is stored in at least one data container as the payload portion of biological data units.

In addition, it should be understood that the BioIntelligence header information and sequence payload that is contained within biological data units relate directly to attributes in XML metadata files and BAM sequence files, respectively. Any key value can associate with one or more sequence files or segments of sequence within such files. In one particular aspect of the disclosed approach, the key value may be information of or pertaining to a drug or its effect and the sequence may be a segment of sequence contained in a genomic sequence object file transfer session.

The BioIntelligence header information may associate with or relate to for example a microRNA sequence or the regulatory region of a gene or interaction with another gene product from at least one molecular pathway. Since the example that is presented as FIG. 1 shows that the payload contains DNA sequence data, the biological data unit of FIG. 1 may also be referred to herein as a DNA protocol data unit (DPDU). The DPDU can be considered as distributed biological data units that are encapsulated with information for transfer, control and other data that is relevant to the protocol.

In one embodiment, the exemplary biological data unit that is depicted in FIG. 1 would be associated with the DPDUs that are encapsulated and involved in a computer-implemented method for processing data units. For example, in the case where the sequence payload is RNA sequence data which may be derived from RNA-seq or deduced from the DNA sequence data could be included within RNA protocol data units (RPDU) comprised of a plurality of RNA specific BioIntelligence headers and a payload comprised of the RNA sequence data. The BioIntelligence header information contained in distributed components of RPDUs may include but not be limited to information on differential expression, splicing, processing and other posttranscriptional modifications of RNA.

Similarly, a protein protocol data unit (PPDU) comprised of peptide-specific BioIntelligence headers and a payload containing a representation of amino acid sequence data. The biological sequence data that is contained in the payload of PPDUs may be from mass spectrophotometry protein sequencing data or deduced from the DNA sequence data of the DPDU of FIG. 1. Furthermore, the BioIntelligence header information may be information such as the protein's concentration in body fluids or the extent of protein activity which could also be associated with the DPDU(s) of the representative gene.

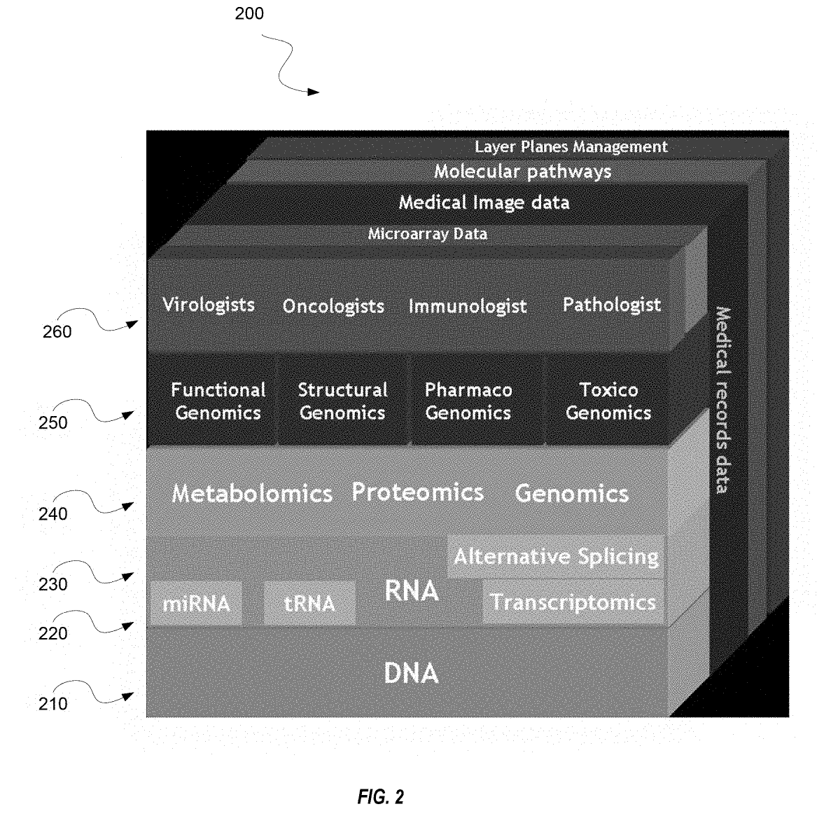

Attention is now directed to FIG. 2, which illustrates a concept for a biological data model which is representative of the associations between and among layers of existing knowledge as well as the intra and interrelationships that exist among and between the highly distributed biological data units described above. In particular, the BioIntelligence headers consisting of information pertaining to the DNA-specific, RNA-specific and peptide specific biological data units are each associated with at least one of the “layers” of the biological data model of FIG. 2, i.e., the DNA, RNA and peptide layers, respectively.

Alternatively, a given biological data unit which may be stored in multiple storage containers may comprise a payload containing a representation of biological sequence data and a plurality of BioIntelligence headers, each of which is associated with one or more of the layers of the biological data model of FIG. 2. As is discussed below, although each BioIntelligence header may be characterized as being associated with a certain layer of a data model, each may also point to or otherwise reference information in the BioIntelligence header or payload of a separate biological data unit that may be stored in multiple storage containers may further be associated with a different layer of the biological data model.

BioIntelligence headers may be associated with any form of intelligence or information capable of being represented as headers, tags or other parametric information which relates to the biological sequence data within the payload of a biological data unit. Alternatively or additionally, BioIntelligence headers may point to relevant or unique (or arbitrarily assigned for the processing purpose) information that is associated with the biological sequence data within the payload.

A BioIntelligence header may be associated with any information which is either known or predicted based upon scientific evidence, and may also serve as a placeholder for information which is currently unknown but which later may be discovered or otherwise becomes known. For example, such information may include any type of information related to the source biological sequence data including, for example, analytical or statistical information, testing-based data such as gene expression data from microarray analysis, theories or facts based on research and studies (either clinical or laboratory), or information at the community or population level based study or any such related observation from the wild or nature.

In one embodiment relevant information concerning a certain segment of DNA sequence or biological sequence data may be considered metadata and could, for example, include clinical, pharmacological, phenotypic or environmental data capable of being embedded and stored in more than one storage container but with very close association with the sequence data as part of the payload or included within a look-up table.

One distinct advantage to storing metadata and sequence files in a manner that allows for effective and robust tracking and linking of the data is that it enables DNA and other biological sequences that make up large data files to be more efficiently processed and managed. The type of information that may be embedded or associated with segments of DNA sequences or any other biological, chemical or synthetic polymeric sequence can be represented in the form of packet headers, but any other format or method capable of representing this information in association with one or more segments of biological sequence data within a data unit is within the scope of the teachings presented herein.

The systems described herein are believed to be capable of facilitating real-time processing of biological sequence data and other related data such as, for example and without limitation, gene expression data, deletion analysis from comparative genomic hybridization, quantitative polymerase chain reaction, quantitative trait loci data, CpG island methylation analysis, alternative splice variants, microRNA analysis, SNP and copy number variation data as well as mass spectrometry data on related protein sequence and structure. Such real-time processing capability may enable a variety of applications including, for example, medical applications.

The types of medical applications that could be facilitated by this approach may include an automated computer-implemented algorithm that allows the storing, filtering, sorting and tracking of an individual's whole genome sequence in segments as they relate to all the attributes and annotations in association with a biological data model of existing knowledge to extract meaningful and relevant results to specific queries. The processing and analysis of this data will unveil a new class of rich BioIntelligence information that can be utilized in accordance with the layered data model of prior knowledge.

BI headers may be used for the embedding of biologically relevant information, in full or in part, in combination with any polymeric sequence or part or combination thereof, and may be placed at either end of such polymeric sequence or in association within any combination of such polymeric sequences. In addition, embedded information can be considered to be information that is clustered and linked in such a way that relevant information that is related to sequence data files are linked to allow for precipitation of meaningful new insight. Furthermore, the various components of the metadata information and sequence segments can be accessible from multiple storage containers on a network.

BI headers may be configured to be in any format and may be associated with one or more segments of polymeric sequence data. Furthermore, in certain cases the components of biological data units may be stored in a centralized container and in such case the BI Headers may be positioned in front of or behind (tail) the polymeric sequence data, or at any set of arbitrary locations within the representation of the segmented sequence data. Moreover, the BI headers may comprise contiguous strings of information or may be themselves segmented and the constituent segments placed (randomly or in accordance with a known pattern) among and between the segments of sequence data which is comprised within one or more biological data units.

The use of BI headers in representing genome sequence data in a structured format advantageously provides an enhanced capability for classifying and filtering the sequence data based upon any of several stored existing knowledge fields that are related to the said sequence segment. This approach allows for the sequence data to be sorted based on the abstracted descriptive information which is contained within the BI headers relating to the segmented sequence data of a specific biological data unit.

For example, the segmented genome sequence data represented by a plurality of biological data units could be processed such that, a particular gene that is normally known to be located at a certain position on chromosome 1 could be sorted along with other genes or gene products from the same or a different chromosome if the corresponding genes or gene products are associated with a particular molecular pathway, drug treatment, health condition, diagnosis, disease or phenotype. Alternatively, it should be known that certain chromosomal rearrangements could generate a similar result when a portion of one chromosome is transferred through translocation and becomes part of another.

In the general case not all of the segments of DNA sequence data within the set of biological data units resulting from segmentation of an individual genome will directly associate with every field of the applicable BI header attributes. For example, a certain biological data unit may contain a segment of DNA sequence lacking an open reading frame, in which case the exon count field of the DNA-specific BI header would not be applicable. In any case, the particular header information type along with other header information types are maintained as place holders for future scaling of the depth and scope of intelligence that is contained within the XML, metadata files. This permits biological information relating to the segmented DNA sequence data of a certain biological data unit which is not yet known to be easily added to the appropriate layer of the biological data model once the information becomes known and, in certain cases, scientifically validated.

In certain exemplary embodiments disclosed herein, the biological or other polymeric sequence data contained within the payload of a biological data unit is represented in a two-bit binary format. However, it should be appreciated that other representations are within the scope of the teachings herein. For example, the instruction set architecture described in co-pending application Ser. No. 12/828,234 (the “234 application”) may be employed in certain embodiments described herein to more efficiently represent and process the segmented genome sequence data within the payload of biological data units. Accordingly, in order to facilitate comprehension of these certain embodiments, a description is provided below of certain aspects of the instruction set architecture described in the '234 application.

### Overview of Instruction Set Architecture for Polymeric Sequence Processing

Set forth hereinafter are the general descriptions for the instruction set architectures comprised of instructions for processing biological sequences, as well as descriptions of associated biological sequence processing methods and apparatus configured to implement the instructions. The instructions may be recorded upon a computer storage medium, and a sequence processing system may contain the storage media and a processing apparatus which can be configured to implement the processing and analysis that is defined by the set of instructions that are designed specifically for operating on the associated attributes. In addition, a computer data storage product may contain sequence data encoded using instruction-based encoding in order to generate a biologically relevant representation of the segmented genome sequence data.

Also described herein is an article of manufacture in a system for processing biopolymeric information, where the article of manufacture comprises a machine readable method for comparative sequence analysis which comprises an instruction set architecture that includes a plurality of instructions for execution by a processor, each of the plurality of instructions being at least implicitly defined relative to at least one controlled sequence, and representative of a biological, chemical, medical, pharmacological, clinical, environmental or physical event affecting one or more aspects of a biopolymeric molecule.

The plurality of instructions may include a set of operation codes corresponding to the biological event and an operand relating to at least a portion of a monomeric unit of the biopolymeric sequence. The one or more aspects may include a monomer of the biological polymer molecule. The event that affects the one or more aspects may include a structural representation of the biopolymeric molecule. The biopolymeric molecule may comprise a segment of a DNA molecule and the monomer may comprise at least a portion of a nucleotide base of the DNA sequence.

### Genomic-Based Instructions

Herein, genomic sequences are defined as sequences of data that is handwritten or stored digitally and describes the genomic characteristics of a particular organism. The term “genomic” in general will refer to sequence data that both encode genes (also referred to as “genetic” data) as well as data that is believed to be non-coding.

The phrase “a particular organism” will mean the organism from which cells were used to prepare DNA for sequencing. Cells will refer to all and any cell type that is integral to the particular organism including normal cells, and tumor cells, cell from plants and animals that may be in the digestive track of the organism. Furthermore, this will include bacteria, viruses and mobile DNA elements that are attached to the organism on the outside or inside. The terms “bacteria” and “viruses” will refer specifically to detection of any evidence of these microbial organisms DNA sequences which may be endogenous or exogenous.

The term “genome” will refer to an organism's entire hereditary information. Genomic sequencing is the process of determining a particular organism's genomic sequence. This term will further reference an organism's inheritable “genome” which will include methylation sequencing epigenomics data as well as microbiomics data and known or predicted non-Mendelian trans-generational transmission of RNA sequence data.

The human genome, as well as that of other organisms, can be generally thought of as being made of four chemical units called nucleotide bases (also referred to herein as “bases” for brevity). These bases are adenine(A), thymine(T), guanine(G) and cytosine(C). Double stranded sequences are made of paired nucleotide bases, where each base in one strand normally pairs with a base in the other strand, according to the Watson-Crick pairing rules, i.e., A pairs with T and C pairs with G (In RNA, Thymine is replaced with Uracil (U), which pairs with A and less often with G).

A sequence is a series of bases, ordered as they are arranged in molecular DNA or RNA. For example, a sequence may include a series of bases arranged in a particular order, such as the following example sequence fragment: ACGCCGTAACGGGTAATTCA (SEQ ID NO.: 1). The human haploid genome contains approximately 3.2 billion base pairs, which may be further broken down into a set of 23 chromosomes. It is approximated that the 23 chromosomes encode about 30,000 genes. While each individual's sequence is different, there is much redundancy between individuals of a particular genome, and in many cases there is also much redundancy across similar species. For example, in the human genome the sequences of two individuals are about 99.5% equivalent, and are therefore highly redundant. Viewed in another way, the number of differences in bases in sequences of different individuals is correspondingly small. These differences may include differences in the particular nucleotide at a position in the sequence, also known as a single nucleotide polymorphism or SNP, as well as addition, subtraction, or rearrangement or repeats or any genetic or epigenetic variation of nucleotides between individuals' sequences at corresponding positions in the sequences.

Because of the enormous size of the human genome, as well as the genomes of many other organisms, storage and processing genomic sequences (which are typically separate sequences generated from a particular individual or organism, but may also be a sequence fragment, sub-sequence, sequence of a particular gene coding sequence or non-coding sequences between genes, etc.) creates problems with processing, analysis, memory storage, data transmission, and networking. Consequently, it is usually beneficial to store the sequences in as little space as possible. At present, there are several well recognized efforts to achieve efficient means to facilitate the smallest footprint. Moreover, it is typically important that no information is lost in storage and transmission. Accordingly, processing for storage or transmission of whole or partial sequences should include removing redundant information in a sequence in a lossless fashion.

Variations in the DNA sequences of different individuals are a result of deviations (also known as mutations). For example, one particular type of mutation may relate specifically to substitutions of nucleotide bases at common or certain reference positions in the sequence. A base substitution (also known as a point mutation) is the result of one base in a sequence at a particular position or reference location being replaced with a different one (relative to another sequence, which may be a reference sequence from which other sequences are compared).

A base substitution can be either a transition (e.g., between G and A, or C and T) or a transversion (e.g., between G and its paired base C or a T, or between A and its paired base T or a C).

### Representation of Polymeric Sequence Data Using Biological Data Units

One aspect the present disclosure describes an innovative methodology for biological sequence manipulation well-suited to address the difficulties that are related to the processing comparative sequence analysis of large quantities of DNA sequence data. The disclosed methodologies enable segmented representations of such sequence data to be efficiently stored (either locally or in a distributed fashion), searched, moved, processed, managed and analyzed in an optimal manner in light of the demands of specific applications.

The disclosed method involves breaking whole genome DNA sequence entries into deliberate segments and packetizing the fragments in association with BioIntelligence header information to form biological data units. In one embodiment much of the BioIntelligence header information may be obtained from private or public databases containing information pertaining to involved molecular pathways, drug databases, published research data that can be found in well-established databases such as, for example, dbGaP and EMBL. The DNA sequence entries within many public databases may be stored in a BAM file format, which accommodates the inclusions of annotated information concerning the sequence. For example, an entry for a DNA sequence recorded in the BAM file format could include annotated information identifying the name of the organism from which the DNA was isolated and the gene or genes contained in the specific sequence entry.

Alternatively, the sequence file may contain the base sequence information while the ancillary metadata information could be contained in XML files as specific attributes that are associated with a particular segment of the sequence. The associated information that is contained in these files may relate with prior knowledge that is configured in a biological model that is consistent with a layered data model.

In addition, the information that is pertinent to which chromosome the particular DNA sequence segment was obtained and the starting and ending base positions of the sequence would also typically be available. Furthermore, other public and private databases include information relating to, for example, the location of human CpG islands and their methylation sequence, as well as the genes with which such islands are associated (see, e.g., http://data.microarrays.ca/cpg/index.htm).

For each identifiable gene there will be an essential need for a normal control state of the particular gene. Database entries that contain genes that are identified as being associated with a RefSeqGene, which pertains to a project within NCBI's Reference Sequence (RefSeq) project, provide another potential source of BioIntelligence header information. The RefSeqGene project defines the DNA sequences of genes that are well-characterized by leaders in the scientific community to be used as reference standards which is a part of the Locus Reference Genomic (LRG) project. In particular, sequences labeled with the keyword RefSeqGene serve as a stable foundation for reporting mutations, for establishing conventions for numbering exons and introns, and for defining the coordinates of other biologically significant variation. DNA sequence entries that associate directly with the RefSeqGene will be well-supported, exist in nature, and, to the extent for which it is possible, represent a prevalent, ‘normal’ allele.

It should be appreciated that there may be different schemas for segmentation and packetizing sequence entries in order to associate the highly relevant attribute information with specific sequence segments. For example, in the case in which it is suitable to segment sequence entries into packets containing genes or, alternatively, into introns and exons, relevant data is available for placement into the BioIntelligence header information relating to the metadata attributes of the biological data units containing such sequence segments.

### Biological Data Units Including BioIntelligence Headers

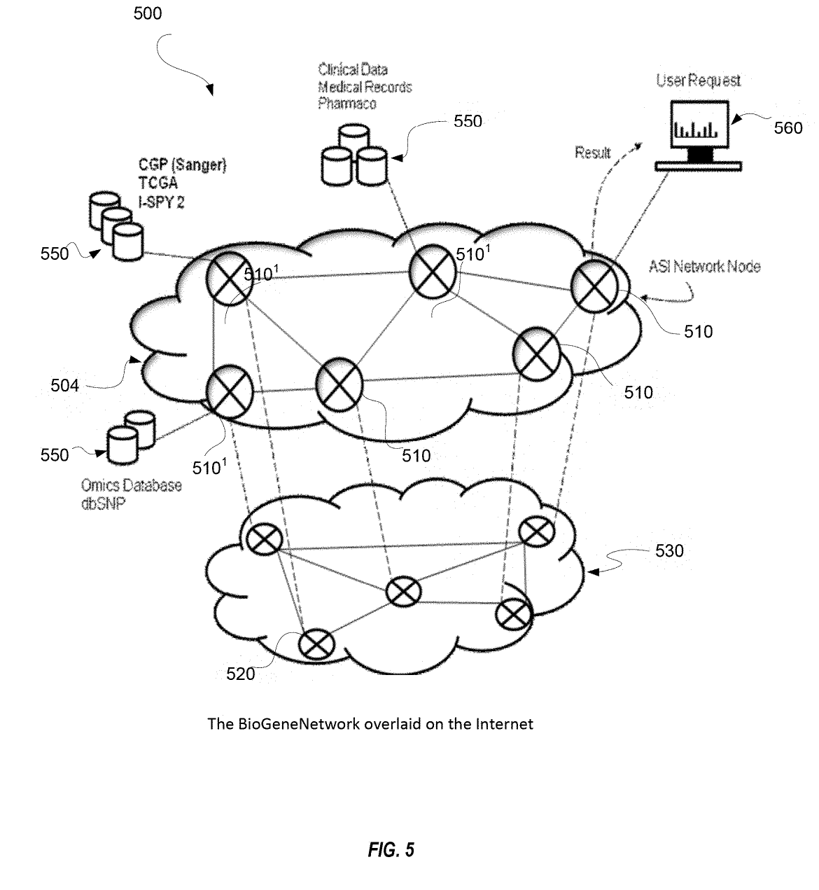

Referring again to FIG. 1, the BioIntelligence header 110 is seen to include a number of fields containing information of biological relevance to the DNA sequence data within the payload 120 of the biological data unit 100. The information that is contained within the BioIntelligence header may be stored in multiple containers on a biological data network. See, e.g., FIG. 5.

In one approach, biological data units are created at least in part by specifically linking information from XML metadata files with particular segments of BAM file sequence data. In this case, the biological data units can be considered a unit of information that a certain relationship that can be stored or streaming from and to multiple nodes on a network. In this case the information that is contained within the BI header distributed and is able to link with sequence segments specifically. The protocols used for the transmission of these precisely related cluster of information in biological data units is integrated with a computer implemented program that defines and classifies the link between and among the BioIntelligence header information and the segment of sequence payload.

It should be appreciated that FIG. 1 provides only one specific exemplary representation of the type of biologically relevant information which may be included within a BioIntelligence header of distributed biological data units. Accordingly, including other types of relevant attributes and information within a BioIntelligence header or the equivalent, regardless of how the data is represented or configured, is believed to be within the scope of the present disclosure.

In addition, although the following generally describes information as being contained or included within various sections of the BioIntelligence header 110, it should be understood that in various embodiments such headers may distributed and may contain pointers, tags or links to other structures or memory locations storing the associated header information.

Similarly, the payload 120 may contain a representation of the segmented DNA sequence data of interest, or may include one or more pointers or links to other structures or locations containing a representation of such sequence data. In this case, the various segments of a particular whole genome sequence may be stored in a distributive manner in multiple containers that are accessible on a network.

A first section 101 of the BioIntelligence header 110 provides information concerning CpG methylation sequence data that pertains to the various positions of the DNA sequence segment within the payload 120 of the biological data unit 100. In other words, the information that is contained in the ancillary files that are associated with the sequence points to section 101. Identification of these CpG islands and the methylation sequence will likely play an important role in understanding regulation of the associated genes and any involvement with disease.

The header information that is contained in section 110 also includes a property of chromosome banding pattern in section 102 containing information concerning any chromosomal rearrangement observed, known, yet unknown and or may be predicted to be involved with at least one segment of genome sequence data linked to this attribute. These types of cytogenetic abnormalities are often associated with severe phenotypic effects. This information may be configured to be in any other format to represent the genomic effects of chromosomal rearrangements which are known to be common in cancer tumor genomics.

Header sections 103 and 104 provide information identifying the beginning and ending positions for the exons that are contained in the DNA sequence segment included within the payload 120. In the case of whole exome sequencing this information represents exons throughout the whole genome that are expressed in genes. Since exon selection has tissue and cell type specificity, these positions may be different in the various cell types resulting from a splice variant or alternative splicing. Along with this DNA coding information for individual exons, header section 105 may represent information in a metadata file of a count of the number of exons contained in the DNA sequence segment included within the payload 120. This type of information is known to be relevant in disorder involving exon skipping and exon duplication.

Certain particular attribute-informational link specifically with one or more DNA sequence segments within payload 120 having some association with a disease will be represented by the attribute information contained within section 106. Information that is pertaining to certain known molecular pathways or systems that may have molecular interactions with other genes or gene products that would also be described within this section of the BI header. Alternatively, since variations of said certain gene could be involved in one or more diseases, such information would also generally be contained within header section 106.

To the extent the DNA sequence segment in the payload 120 contains a part of a gene, a gene or plurality of genes, then the header section 107 provides all of the pertinent information that relate specifically to the applicable known gene name or gene ID. Header section 108 may represent the type of information that specifies the tissue or cell type which may be relevant to the extent and level of expression of the various exons that may be encoded in the said gene or segment of genome that is described in section 105.

The metadata attribute located in the header section 109 will provide information concerning all possible open reading frames present within the segment of genome sequence data that is contained within the payload 102. This type of BioIntelligence attribute will be crucial for characterizing disease associated variants which are contained within what appears to be open reading frames that express no proteins or peptides that are detectable with today's methods.

Header section 110 and 111 represent the metadata annotations that specify the start and end positions of the DNA sequence segment that is linked to a specific segment of a BAM file , represented by the payload 102. These positions may be considered arbitrary since the positions in the sequence could be more than one reference sequence.

Section 112 indicates if the segmented DNA sequence data within the payload 102 is chromosomal, microbial or mitochondrial. Furthermore, section 113 provides information concerning the genus and species of the origin of the DNA sequence segment represented with the payload 102. It should be appreciated that sections 112 and 113 will provide the information that describes all the DNA sequence data that is associated with an individual including and not limited to microbes attached on the outside and found on the inside of said individual as well as genome sequence data from plants and other higher animals found in the digestive track.

All of the metadata annotations and attributes that are within the header 110 will generally contain prior knowledge information relating to the BioIntelligence that is relevant to the DNA sequence which is functionally utilized while the data is being sorted, filtered and processed. This packetized structure of the DNA sequence data that is represented in bits and encapsulated with BioIntelligence headers and other relevant information advantageously facilitates processing by existing network elements operative in accordance with layered or stacked protocol architectures.

For example, The Cancer Genome Atlas consortium has elected to implement biological data units comprised of BioIntelligence headers consisting of information contained in XML metadata files and payloads comprised of genome sequence data contained in the BAM files. In this exemplary implementation a first specific type of BioIntelligence information may reference the tissue type or cell type of the sequence files (section 108 of FIG. 1). Similarly, second specific type of BioIntelligence information type may reference a disease type (section 104 of FIG. 1).

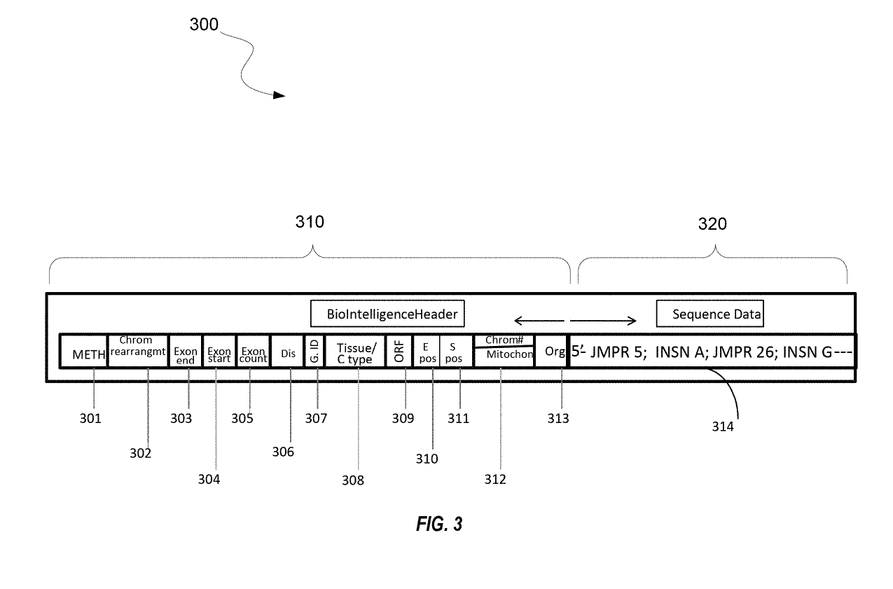

Attention is now directed to FIG. 3, which depicts a biological data unit 300 having a BioIntelligence header 310 and a payload 320 containing an instruction-based representation of segmented DNA sequence data. The type of information that is illustrated in 310 is exemplary. Moreover, this information may be stored in one or more storage containers that are accessible on a network. The instruction-based representation is discussed above and in the copending '234 application. Although the content and representations of the payloads 110 and 310 differ, the same type of information is included within the BioIntelligence headers 110 and 310 of the biological data units 100 and 300, respectively.

The distributed packetizing of segmented DNA sequence data files and the embedding of biologically and clinically relevant information in biological data units will enable development of a networked processing architecture within which such data may be organized and configured in a layered format. Based on preliminary results, the architecture is expected to be particularly suited for effecting rapid analysis of large amounts of data of this type.

In one approach, the header which is contained within such biological data units, is used to qualify or characterize the fragmented or otherwise segmented genome sequence data included within the payloads of such data units. In so doing, biological data units containing segmented DNA sequence data or other sequence data may now be sorted, filtered and operated upon based on the associated attribute information contained within the ancillary metadata files of the highly distributed data units.

For example, a data repository containing biological data units incorporating segmented DNA sequence data and related attribute information similar to that associated with the header 110 of FIG. 1 may be quickly and efficiently sorted in accordance with parameters defined by an application. This has been recently demonstrated with a system that has reduced to practice the concepts and ideas of the current disclosure as the repository that is now known as the Cancer Genome Hub (CGHub) operated by the University of California. In other words, the same segments of genome sequence may be sorted and analyzed in several different ways by using the header information associated with, or otherwise directly or indirectly linked to, the payload representation of the sequence segments.

It is highly expected that it would be beneficial to arrange and represent all of the genomic sequence information from an individual, e.g., from bacteria, animals, plants to humans, in accordance with the layered data architecture illustrated in FIG. 2. For example, consider the case in which a segment of a genome sequence data file of interest is included as the payload of a biological data unit stored in a data container which includes biological data units associated with DNA sequence data of other organisms.

Consider further that if, for example, the DNA sequence data of interest is a particular variant of a human gene associated with breast cancer, such as BRCA1, then such data could be extracted from the container by filtering the contents of the data container for metadata attributes associated specifically with the segment of DNA sequence data from the organism homo sapiens. The data units containing the specific BRCA1 variant along with all other DNA data packets containing human DNA sequence data may be easily extracted. However, sorting human DNA sequence data from the DNA sequence data from other organisms may not be sufficient enough of a challenge in view of the technical requirements of certain applications. Accordingly, additional processing and comparative analysis may be performed in which specific data units comprising certain segments of sequence data from human chromosome 17 would be filtered out from the data container.

Biological data units having payloads containing DNA sequence segments from chromosome 17 may provide a reasonable level of filtering. However, in order to efficiently analyze the gene most notably associated with breast cancer, further processing, sorting and filtering will be necessary. This may be achieved using several methods including but not limited to filtering on the specific start and end positions within the chromosome (S pos and E pos) or the gene ID (GID) or by disease, breast cancer. If the biological data units that are being sorted contain sequence segments data associated with an alternately-spliced variant of BRCA1, then this information may be contained in the header information representing the total exon count (see, e.g., header section 105 of FIG. 1), in addition to within the header sections including start exon and end exon information sections (see, e.g., header sections 103 and 104). Furthermore, additional information concerning tissue or cell type may need to be provided in order to perform the most intricate level of sorting and filtering of the biological data units associated with a specific BRCA1 variant.

The packetized structural configuration of the disclosed distributed biological data units further enable functional integration of a layered data models such as that depicted in FIG. 2. In particular, each metadata attribute of BioIntelligence headers forming at least a part of or is linked to a particular biological data unit which may be associated with one or more specific layers of the model. One advantage of using a layered data model is that data from the various layers may interrelate during processing of the header information included within the set of biological data units being operated on or otherwise analyzed. For example, in the exemplary case described above, information from the RNA layer of the model relating to the splicing of introns from pre-mRNA was used to identify BRCA splice variants, thereby correctly facilitating determination of exon start and end positions.

The use of BioIntelligence header information which are consistent with a layered data architecture also advantageously enables substantial changes to be made to the information associated with one layer of the model without necessitating that corresponding modifications be made to other layers of the model. For example, sequence variants may be observed at splice donor and splice acceptor sites which may change the splicing pattern and mRNA size, protein structure and function, and these changes may yet be accommodated and mapped to the DNA layer without requiring that corresponding changes be made the DNA layer of the existing knowledge data model.

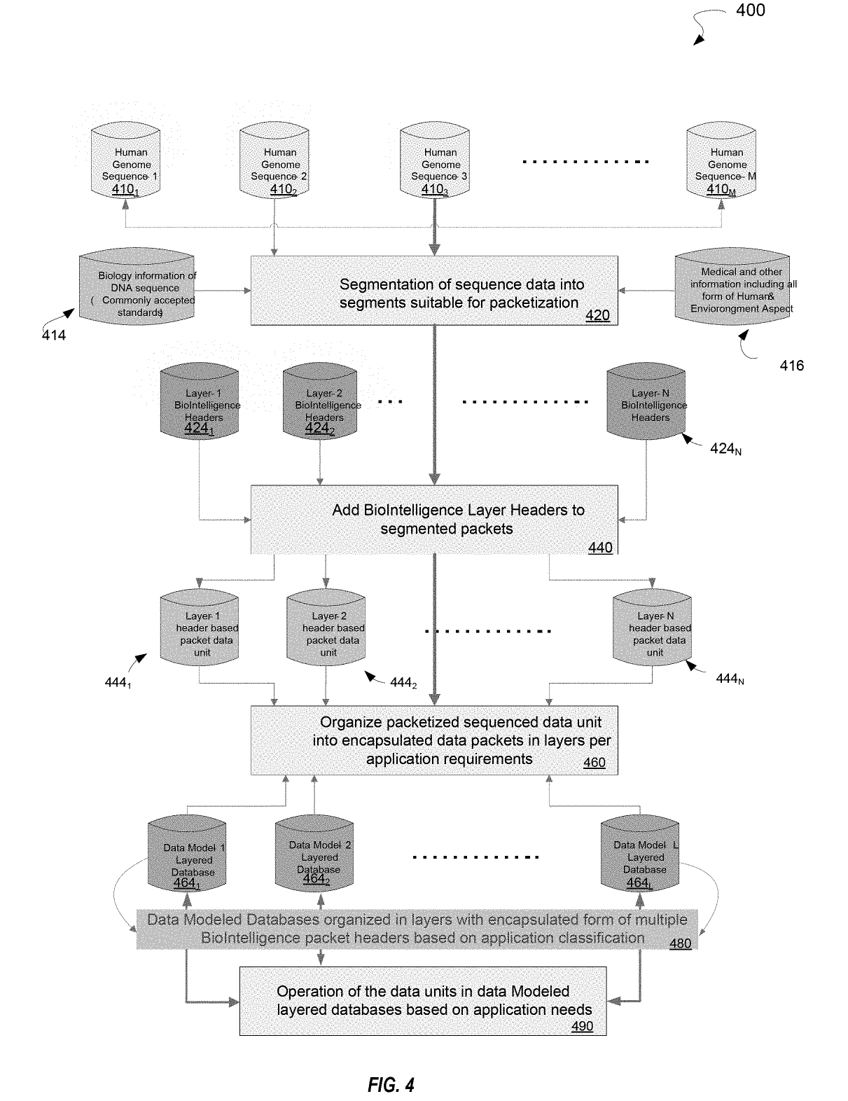

Attention is now directed to FIG. 4, which provides a logical flow diagram of a process 400 for segmentation of biological sequence data and combining the segments with metadata attributes to form biological data units encapsulated with BioIntelligence headers. The process 400 provides one example of a way in which source DNA sequence data may be fragmented to generate biological data units containing DNA sequence segments and associated BioIntelligence header information in accordance with a layered data model such as the biological data model 200.

In one embodiment the process 400 utilizes sequence feature information of the type annotated in well-established nucleotide databases 410 such as, for example, NCBI, EMBL and DDBJ for sorting, configuring and operating on the sequence data. By mapping the biological information within these databases into various layers of BioIntelligence header information, a layered data model of existing knowledge can be constructed.

Referring to FIG. 4, human genomic DNA data is shown to be accessible from different storage elements 410. In this regard, the DNA sequence data can be stored in segments as sequences of individual chromosomes or partial chromosomes or as individual genes, and may comprise all or part of a genome. In addition, the DNA sequence data could be generated from a sequencing machine and the results made accessible to a network of computers. Further, genomic sequence data might be represented in any file format and produced using any approach including, for example, as a partial dipolar charge and phosphorescence sequence profile indicative of the sequence data.

In a stage 420, the sequence data obtained from storage elements 410 is mapped and aligned with the reference genomic sequence data. The DNA sequence is associated with a set of relevant molecular features using, for example, biological data 414 deemed valid by the scientific community. This data 414 is mapped to specific regions of a sequence entry. In addition, clinical and pharmacological data 416 demonstrated to be associated with any coding or non-coding regions of a sequence entry is also mapped.

In one embodiment layer-1 biological data units 444₁ include a payload comprised of segmented DNA sequence data and a DNA layer header. Similarly, layer-2 biological data units 444₂ may include a payload comprised of segmented DNA sequence data, a DNA layer header and an RNA layer header. A layer-N biological data unit 444N may include a payload comprised of segmented DNA sequence data, a DNA layer header, an RNA layer header, and other headers associated with higher layers of the relevant data model.

Alternatively, in one embodiment layer-1 biological data units 444₁ may include a payload comprised of segmented DNA sequence data and a DNA layer header, layer-2 biological data units 444₂ may be comprised of a segmented RNA sequence data and an RNA layer header, and so on. In one embodiment a base unit may be prepended to or otherwise associated with each biological data unit in order to identify the specific headers included within the data unit and/or the number thereof.

In one embodiment BioIntelligence headers 424 may include physical, chemical, or biological knowledge or findings, or any related molecular data that has been peer reviewed, published and accepted as valid. BioIntelligence headers 424 may also include clinical, pharmacological and environmental data, as well as data from gene expression and methylation.

In certain embodiments BioIntelligence headers 424 may further include information relating to gene and gene product interaction with other components of a pathway or related pathways. The information within BioIntelligence headers 424 may also be obtained form, for example, microarray studies, copy number variation data, SNP data, complete genome hybridization, PCR and other related techniques, data types and studies.

The prior scientific knowledge and information associated with a specific sequence and included within a BioIntelligence header 424 may be of several different types including, for example, molecular biological, clinical, medical and pharmacological information. In this regard such molecular and biological information could be separated and layered based on data from, for example, genomics, exomics, epigenomics, transcriptomics, proteomics, and metabolomics in order to yield BioIntelligence data.

The BioIntelligence data may also include DNA mutation data, splicing and alternative splicing data, as well as data relating to posttranscriptional control (including microRNA and other non-coding silencing RNA and other nuclease degradation pathways). Mass spectrometric data on protein structure and function, mutant protein products with reduced or null function, as well as toxic products could also be utilized as BioIntelligence information.

In addition, pharmacological and clinical data relating to specific genes or gene regions disposed to exert effects through interaction with gene products or other components of a pathway could be considered as a class of BioIntelligence header information. Finally, BioIntelligence header information could also include environmental conditions or effects correlated with certain genes or gene products known or predicted to be related to a certain phenotypic effect or disease onset.

As mentioned above, during stage 440 BioIntelligence headers 424 are associated with segmented DNA sequence data form biological data units comprised of a BioIntelligence header 424 encapsulating a payload containing the segmented DNA sequence data. In this process the association of a BioIntelligence header 424 to payload containing segmented genome sequence data may be carried out in any of a number of ways. For example, such association may be effected using a pointer table, tag, graph, dictionary structure, key value stores or by embedding header information directly into the segmented sequence data.

In a stage 460, the biological data units 444 may be organized into encapsulated data units in accordance with the requirements of particular applications. For example, in certain cases it may be desired to create encapsulated biological data units including only a subset of the headers which would otherwise be included in the biological data units associated with at least one particular layer of the biological data model of prior knowledge. For example, a certain application may require encapsulated biological data units having headers associated with only layers 1, 2 and 5 of a data model.

Another application may require, for example, encapsulated biological data units having headers associated with only layer 2, 3 and 4 of the data model. Similarly, other applications may require that the headers of the encapsulated biological data units be arranged in a particular order, e.g., the header for layer 4, followed by the header for layer 1, followed by the header for layer 2.

In a stage 480, the encapsulated biological data units created in stage 480 are stored in a manner consistent with being interoperable with one or more multi-layered, multi-dimensional data containers 464. The content of the headers of the encapsulated biological data units is chosen to promote optimal interoperability among and between layers. For example, in one simplified case each biological data unit included within the data container 464₁ may include at least a DNA layer header, an RNA layer header, and a protein layer header. It is a feature of the present system that information within higher-layer headers (e.g., RNA layer headers or protein layer headers) may be “mapped” to lower-layer headers and/or sequence information in such way as to establish a relationship provenance between information within various layers.

Consider an example wherein data concerning a particular protein product that is expressed in a certain tissue type (i.e., protein layer information) may also provide information relating to splicing (i.e., RNA layer information) or to a SNP at the genomic level (i.e., DNA layer information) resulting in a premature termination codon. In other words, protein structure related data can provide RNA level knowledge on alternative splicing as well as data on primary sequence data of amino acids substitutions revealing SNPs and indels at in the DNA sequence.

In another case, the diagnosis of a certain disease in a certain patient or, for example, results from a mammogram screen or prostate-specific antigen results, may provide information that is directly related to hyper-methylation of certain regions of the DNA sequence segment included within a DNA layer biological data unit. These epigenetic markers, along with the methylation profile at CpG islands associated with certain genes, could provide crucial BioIntelligence header information to relate and correlate with appropriate gene and disease conditions.

One advantage of the layered architecture of the data containers 464 is that modification or updating of the data content associated with a given layer has minimal or no effect on the processing of data in the remaining layers. In one embodiment layers are advantageously designed to be operated on independently while retaining the capability to integrate, and interoperate with, data and existing knowledge of other layers. In addition, data can be organized within each data container 464 in accordance with the requirements of specific applications.

All or part of this data may be mapped, via linked relationships between information within BioIntelligence headers or metadata attributes that are associated with different layers of a data model, to a disease condition capable of being associated with a region of segmented DNA sequence data contained within a biological data unit. This enables biological data units to be grouped and analyzed based upon the classification schema required by a particular application.

In a stage 490, biological data units encapsulated with BioIntelligence headers and stored with the data containers 464 may subsequently be filtered, sorted or operated upon based on information included within such headers. The layered structure of biological data units comprised of biological data units including encapsulated BioIntelligence headers enables querying of the information included within one or more such headers to be performed and results returned based upon a set of rules specified by, for example, the application issuing the query.

Attention is now directed to FIG. 5, which depicts a biological data network 500 comprised of representations of biological data linked and interrelated by an overlay network 504 containing a plurality of network nodes 510. In one embodiment the network nodes 510 are in communication via network elements 520 (e.g, routers and switches) of the Internet 530 and thus overlay such Internet elements. Certain of the network nodes 510′ may have localized access, via a local area network or the like, to databases 550 containing the representations of biological sequence data, clinical data, or other information which are networked in the manner described herein. In one embodiment the network nodes 510′ may be configured to locally process information within a database 550 and make available all or part of the results of such processing, and potentially information within the database 550 itself, to other of the network nodes 510. In addition, the network nodes 510′ may also be designed to perform network processing functions along with the network nodes 510 in the manner described hereinafter.

The biological data network 500 may in one aspect be viewed as comprising a network of data stored within the databases 550 as well as within storage (not shown) at the network nodes 550. In one embodiment each biological data sequence or other sequence information stored within the network 500 may be accorded a unique identifier such as, for example, an IP address, in order to facilitate the establishment of such a data network. Moreover, tables may be maintained at each network node 510 for data tracking purposes (references herein to network node 510 are generally also intended to refer to network nodes 510′, unless the context of the reference clearly suggests otherwise). In particular, such tables may be used to track the sequence information available directly or indirectly (via other network nodes 510) from other network nodes 510, as well as the results of processing such sequence information at various nodes 510. These tables may be updated as biological data units containing sequence information and/or BioIntelligence and or MetaIntelligence™ headers are transported between nodes for processing. Alternatively or in addition, overhead messages may be exchanged between network nodes 510 for the purpose of propagating the information stored within ones of these table to the tables maintained by other nodes 510. Such messaging and updating of tables between network nodes 510 generates a type of BioIntelligent data awareness that provides a distinct advantage for processing and sharing data on network 500. Furthermore, the network processing that is carried out allows seamless access to network-associated processing functions, shared data as well as support databases that also contain properties of and information about the data.

### Structure and Operation of Network Nodes of Biological Data Network

During operation of the network 500, requests from a client terminal 560 are received by a network node 510. Such requests are interpreted at the network node 510 and appropriate processing is carried out at such network node 510, and potentially other network nodes 510, in order to produce the requested results. In this regard BioIntelligence headers relating to all of the data throughout the network 500 that is designated as or otherwise made network accessible may be accessed and processed in response to requests from a client terminal 560. In this way intelligent information concerning data stored remote from a client terminal 560 and its associated network node 510, and/or such data itself, may be processed in a manner transparent to such terminal 560 and node 510.

Although certain of the embodiments disclosed herein contemplate that various ones of the network nodes 510 may perform specialized processing functions and operate cooperatively to produce an overall processing result, in other embodiments certain nodes may be capable of performing all of the processing functions necessary to deliver results in response to queries.

In certain aspects of the invention whereby cooperative operations and processing functions are coordinated at various distributed network nodes 510 queries can be made that would facilitate the simulation, study and comprehension of systems in biology. In this case, BioIntelligence header information fields at the DNA, RNA and protein layers along with query dependent processing function requirements serve as the activated substrates for generating a result.

In general, when a query/request is made, a suite of protocols are invoked which are based upon the properties of the request. For example, a request can be made from any client on the network 500 and the stack of application protocols use processing functions at multiple nodes to access the associated data and a process management function to tabulate, coordinate and combine the partial information from multiple nodes to return the query result. In this regard, processing at a network node 510 can be achieved using either of at least two approaches. In a first approach of cooperative processing functions, data and or partial processing results can be moved to the desired functional node 510 to be processed. Alternatively, the required processing function can be moved form a network node 510 to the location of the network accessible data at 550 and the data is processed at the site at which it resides on the network 504. Furthermore, a combination of the two approaches can be used to return the query result to end nodes or terminals 560. In addition, any result from processing that is new network information can be used to update tables at nodes 510 to enhance network awareness.

The network nodes 510 are aware of the types, the content and location of all network accessible data and its intelligence. Moreover, the network nodes 510 are aware of the types, locations and capabilities of processing functions on the network 504. In this regard each node 510 is regularly updated with the activities being performed by, and processing results generated by, each other node 510 of the network 500. In one embodiment, network-based applications and protocols are aware of the information contained in the different fields of the BI headers associated with the biological data units stored within the databases 550 and access such information to the extent necessary to process queries from terminals 560.

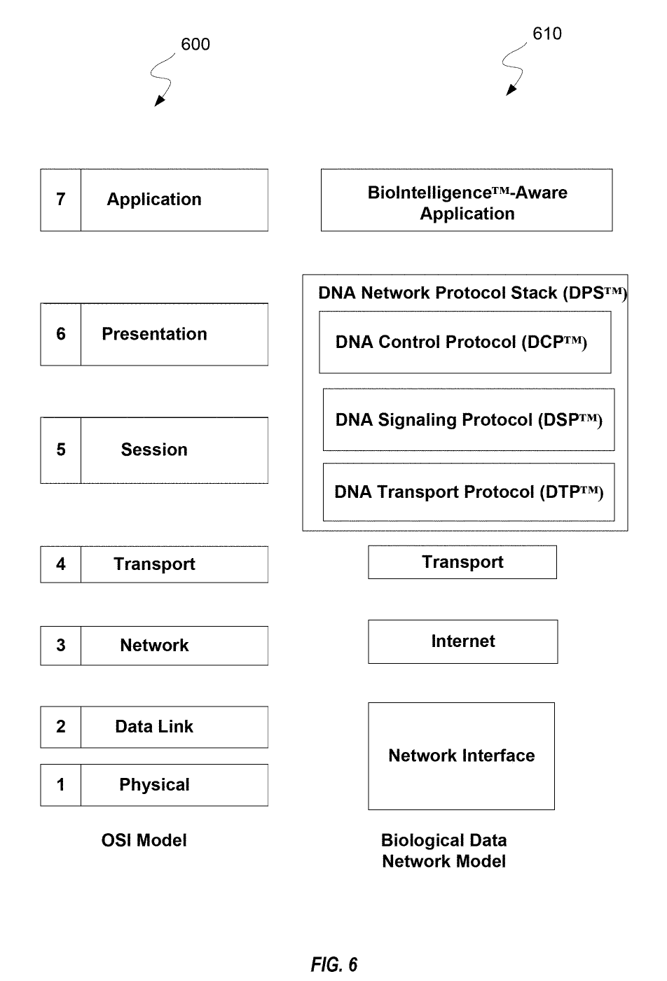

Turning now to FIG. 6, there is illustrated an exemplary protocol stack 610 implemented at a network node 510 together with corresponding layers of the OSI network model 600. As shown, the protocol stack 610 includes a DNA Network Protocol Stack (DPS™) over TCP/IP layers. The DPS™ supports a BioIntelligence-Aware Network Application capable of processing requests from a client terminal 560 and delivering results. As is discussed below, a network node 510 configured with the protocol stack 610 is capable of performing processing, switching and routing functions based upon not only the information within messages associated with the TCP/IP layers of the protocol stack 610 but also in accordance with the higher-layer information within BioIntelligence headers and other information associated with the DPS™. As a consequence, a network node 510 may use this higher-layer information to prioritize the processing of packets received by the network node 510. For example, the network node 510 may control quality of service (“QoS”) and effect load balancing based upon this higher-layer information.

The DPS™ is intended to enable existing Internet infrastructure to efficiently process and transport DNA sequence-based data. The DPS™ protocol stack comprises a DNA Transport Protocol™ (DTP™), DNA Signaling Protocol™ (DSP™), and DNA Control Protocol™ (DCP™). In one embodiment the DTP™ protocols enable network elements such as routers and switchers to process, transport, and communicate biological data such as DNA sequence data and related information between single or multiple sources of streaming DNA servers (discussed below). The servers will include or have access to data containers (e.g., storage devices) including biological data units and/or unprocessed or partially processed DNA sequence data.

The functions of the DPS™ protocol suite comprise processing, transporting, controlling, switching and routing biological data such as DNA sequence information as streaming data so as to enable such data to be utilized for a variety of “streaming” applications. In this regard the DPS™ protocol stack will be used for pulling streaming biological data from servers having access to containers of biological sequence data. Such streaming applications are capable of continuously “pushing” and “pulling” biological sequence data as necessary to support the functionality of each particular application.

Various options exist for introducing the DPS™ protocol suite into existing network infrastructure. In one implementation, for example, the DPS™ protocol suite may be distributed throughout the routers/switches of a given service provider. In another implementation, the DPS™ protocol suite may reside only in one or more network elements near an edge of the service provider's network in an overlay network.

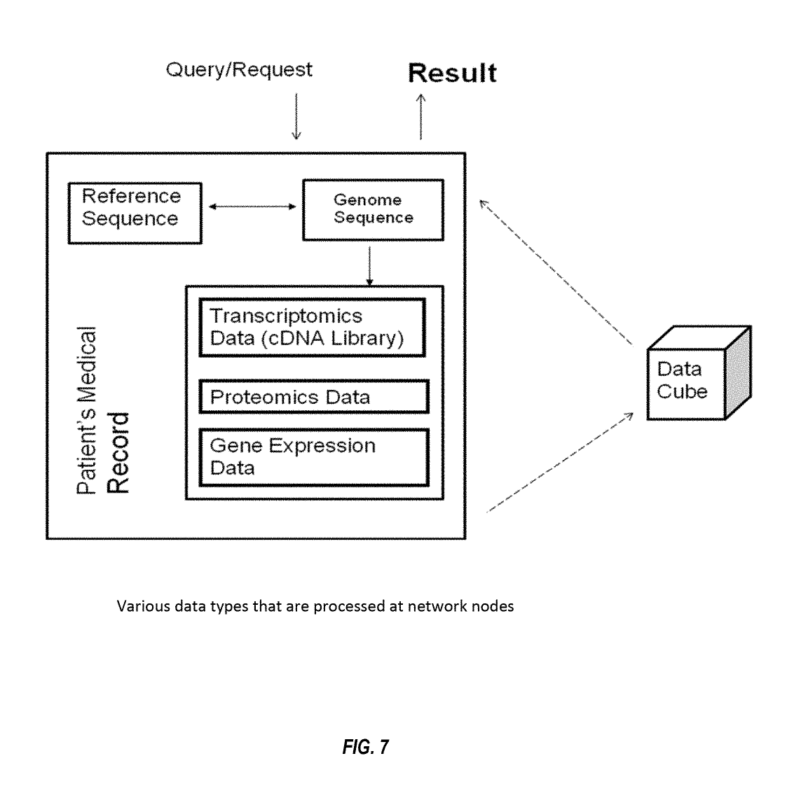

FIG. 7 shows a high-level view of the various data types that may be processed by a group of network nodes 510 in response to a query/request received from a client terminal 560. As shown, transcriptomics data, proteomics data and/or gene expression data stored as biological data units within databases or data containers accessible to the nodes 510 may be processed.

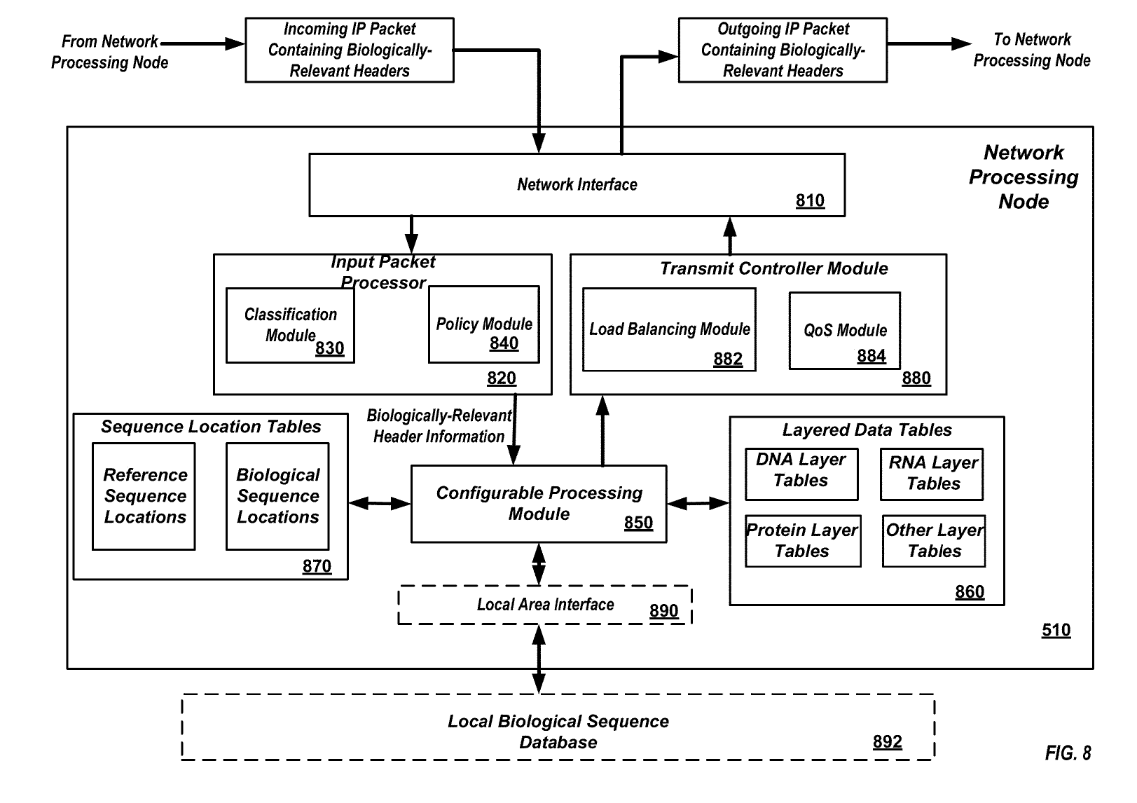

Attention is now directed to FIG. 8, which provides a block diagrammatic representation of the architecture of an exemplary network node 510. As shown, the network node receives incoming IP packets containing BioIntelligent biologically-relevant headers. Encapsulated within such incoming IP packets will typically be, for example, information identifying the particular gene(s) with which such biologically-relevant headers are associated. Such information could include, for example, the particular chromosome and position within the chromosome with which the gene is associated, protein information associated with the gene, whether the gene corresponds to a normal or minor allele, or other information pertinent to the gene. In addition, each incoming packet could also include information uniquely identifying the specific DNA sequence or other biological sequence information and the network location at which such sequence is stored. For example, such identifying information (which could be in the form of, for example, an IP address separate from the IP address of the incoming IP packet) could identify a particular network-accessible database and a location or position with such database. In other embodiments both information identifying the gene associated with the biologically-relevant headers within the incoming IP packet and information specifying a particular location at which the sequence information associated with such headers is stored could be inherent within a unique identifier included within the incoming IP packet.

Each incoming IP packet containing biologically-relevant headers is received via a network interface 810 and provided to an input packet processor 820. In one embodiment the network interface is comprised of a physical port in communication with an external network and further includes, for example, buffers, controllers and timers configured to facilitate transmission and reception of packetized sequence data and other information over such network. The input packet processor 820 removes the IP header information and parses the higher-layer content included within the packet. A classification module 830 may then assign the packet to a particular class based upon this higher-layer content. The biologically-relevant header information included within the packet may then be passed to a configurable processing module 850 for processing in the manner described hereinafter based upon the determined class and any policies applicable to such class defined by policy module 840. As is also described hereinafter, the biologically-relevant header information may then be processed by configurable processing module with reference to various sequence location tables 870 and layered data tables 860 maintained at the network node 510. The layered data tables 860 are structured consistently with the biological data model (FIG. 2) used to define the biologically-relevant headers within each incoming IP packet.

Based upon the results of the processing performed by the configurable processing module 850, outgoing biologically-relevant header information associated with the biological sequence identified within the input IP packet or other processing results is provided to a transmit controller module 880 for packetization within an outgoing IP packet. To the extent the outgoing biologically-relevant header information requires further processing by another network node 510 in order to render an appropriate response to the user request received by the network 500, a load balancing module 882 within the transmit controller module 880 selects such a network node 510 from among the group of such nodes capable of performing the required processing. Such selection may be based upon, for example, the processing loads associated with each node within the group. Additionally, selection may be based upon processing results that are passed to the transmit controller module 880. A QoS module 884 places each outgoing IP packet in one or more queues in accordance with, for example, the applicable class accorded the corresponding incoming IP packet by the classification module 830 and the policy associated with such class. Each outgoing IP packet will generally include identifying information similar to that included within each incoming IP packet. The outgoing IP packets are provided by the transmit controller module from the applicable queue to the network interface for transmission to a destination network node 510.

In one embodiment the BioIntelligence headers within each IP packet received by a network node 510 will be functionally associated with or contain information having biological relevance to a segment of DNA sequence data, MetaIntelligence™ metadata, or both. It should be appreciated that the BioIntelligence headers may be arranged in any order, whether dependent upon or independent of any associated payload data. However, in one embodiment the BioIntelligence headers are each respectively associated with a particular layer of a biological data cube model representative of the biological sequence data contained within the payloads of the biological data units with which such headers are associated. Moreover, it should be understood that any patient-related data which is not predicated upon genomic sequence information but is nonetheless pertinent to the processing by the network 500 of a request may be included within the BioIntelligence headers of a received IP packet.

It should be further understood that BI headers may be realized in essentially any form capable of embedding information within, or associating such information with, all or part of any biological or other polymeric sequence or plurality thereof. BI headers may also be placed within a representation of associated DNA sequence data, or could be otherwise associated with any electronic file or other electronic structure representative of molecular information. In particular, biological data units containing segmented DNA sequence data may be sorted, filtered and operated upon based on the associated information contained within the BioIntelligence header fields.

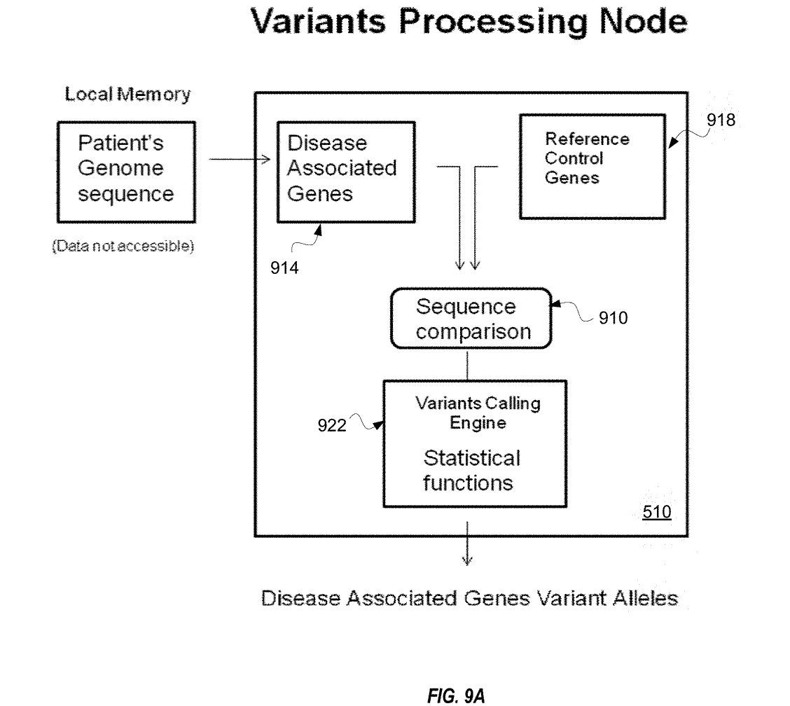

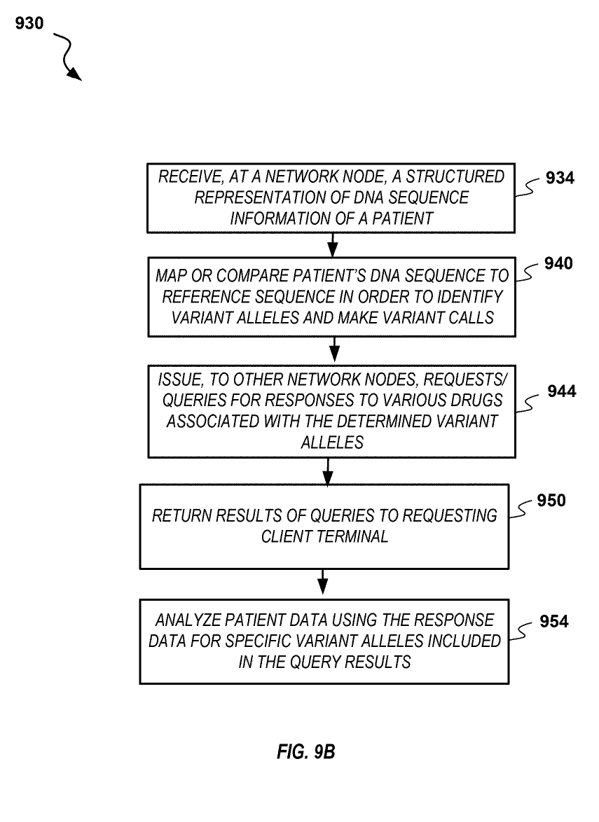

Attention is now directed to FIG. 9A, which illustratively represents a process effected by a network node 510 to implement a sequence variants processing procedure. In many instances the first process performed within the network 500 in response to receipt of a user query is the execution of a variants calling function at a network processing node 510. The variants calling function may be executed at the network node 510 receiving the user query. Alternatively, the procedure may be executed at a network node 510 specially configured for performing a comparative analysis of the subject patient whole or partial genome sequence against the selected reference/control sequence.

In an initial step of the variants processing procedure, a determination is made as to whether any differences exist between the biological data sequence associated with the query and the reference sequence. To the extent differences are detected, the nature of the differences and their locations with respect to the reference sequence are recorded. In this regard the sequence data associated with the query could comprise a portion of a gene or plurality of genes, an entire genomic sequence from normal cells, and/or an entire genomic sequence from diseased cells. The sequence data for a particular patient could comprise any, or a combination, of these types of sequence data.

In other embodiments a clinically transformed version of a patient's genomic sequence data, rather than the sequence data itself, is associated with user requests received by the network 500. Such a clinical transformation may involve, for example, associating a patient's medical records or health related information with any or a combination of the patient's genomic sequence or the patient's transcriptomic, proteomic, metabolomic or lipidomic information, or any other such related data. For example, such transformation could involve using certain minor allele variations in or near certain genes that are associated with certain phenotypes, symptoms, syndromes, diseases, disorders, etc. Furthermore, certain knowledge of the linkage disequilibrium that is associated with the haplotype map genome sequence of the patient might provide a detailed transformation of this genotyping data into information on protein concentrations in blood, urine and other body fluids. Information on functional activity of these proteins and their metabolic state which might include posttranslational modifications could be a useful part of improving the granularity of the patient's genomic-based transformed data. Accordingly, the present disclosure advantageously provides a mechanism for networking and sharing genomic-based data without requiring a corresponding sharing of a patient's genomic sequence data.

Again considering the process of FIG. 9A, in a comparison operation 910 packets of genomic sequence segments 914 are mapped to corresponding portions of a reference sequence 918. In an operation 922, statistical corrections are then carried out at the network node 510 on the basis of the comparison in order to make a variant call. Variants calls can be checked against a database of variant alleles since each node has awareness of such data location on the network. For example, a rare variant in a certain gene associated with breast cancer might be contained in TCGA database with pertinent information on drug response. This information will have information on clinical responses to certain drugs that relate directly to the minor allele. The network can access the TCGA database and extract the required information for processing on the network or locally at the client server. The MetaIntelligence information about the data within the TCGA database can then be used to allocate processing functions.

For simplicity, in the case where SNPs are the only variants dbSNP can be used to validate common SNPs. In addition, data on minor alleles with disease association might be present in other cancer genome databases that are maintained by public and private entities such as but not limited to CGP (Cancer Genome Project at Sanger Institute), TCGA (at NIH's National Cancer Institute), RCGDB (Roche Cancer Genome Database), and the like.

Attention is now directed to FIG. 9B, which is a flowchart of an exemplary variants processing procedure 930 representative of one manner in which a network node 510 configured for variants processing may be utilized in connection with processing a particular user request. In particular, consider the case in which a structured representation of the DNA sequence data of a breast cancer patient is received at a network node 510 configured for variants processing along with a reference sequence (stage 934). The structured sequence data is then mapped against the reference in order to produce the specific variant alleles forming the basis of variants calls made by the node 510 (stage 940). In this example it is assumed that the request accompanying the sequence data comprised a request to determine the pharmaceutical drug with the highest efficacy and with lowest toxic effects in view of the DNA sequence data of the patient. Once the specific variant alleles of the patient have been determined, the network node 510 configured for variants processing may issue a query/request that is processed by those network nodes 510 having access to public and private databases containing information relating to pharmacogenomics-based responses to various drugs (stage 944). The results of such queries may then be returned to the requesting client terminal 560 (stage 950), and the drug response data for specific variant alleles included within such results may then be used for analysis of the patient data (stage 954).

In the general case, once the processing to be performed at a given network node 510 has been completed, a decision will be made to route or switch the processing to another network node 510 based upon the results of such processing (stage 960). The extent of the processing to be performed by the network 500 with respect to a particular request will of course be dependent upon the nature of the request.

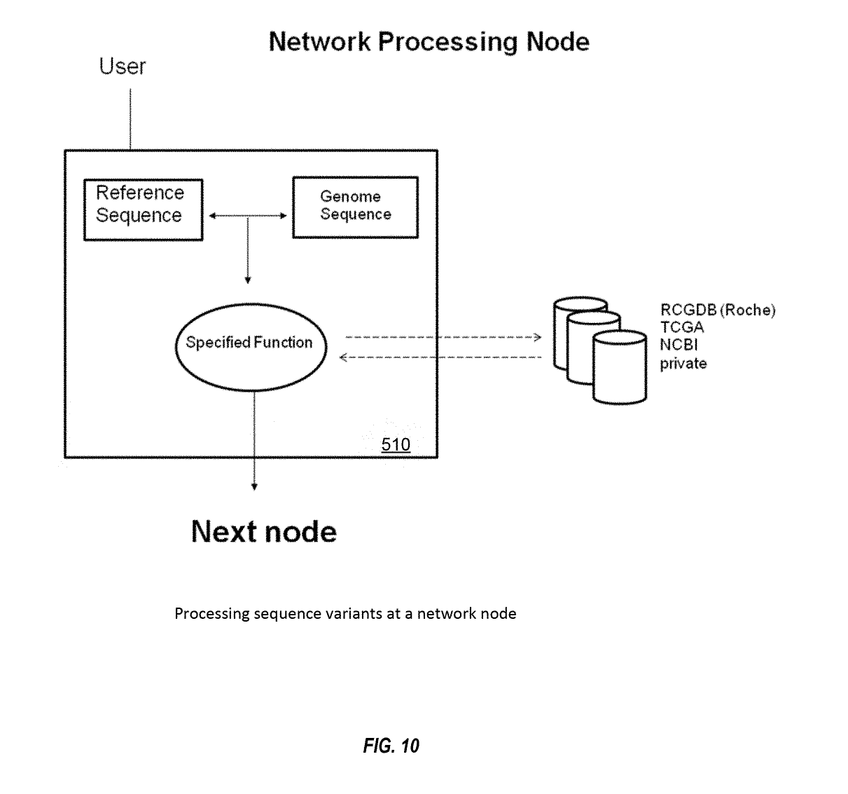

Turning now to FIG. 10, an illustrative representation is provided of the processing occurring at a network node 510 configured to perform a specialized processing function. As may be appreciated with reference to FIG. 10, a specialized processing function which is required to be performed is first carried out and the result of such a processing function is supported by access to public and private databases with relevant associated data.

In one embodiment each network node 510 implements a method which generally involves performing a processing operation involving ones of a first set of biological data units and a second set of biological data units. The processing might further involve a comparison of the called variant with access to established variants databases.

In the general case, the biological data unit encapsulated within the IP packet received by a network node 510 will contain a first header associated with first information relating to segmented biological sequence data and a second header associated with second information relating to the segmented biological sequence data. The method includes processing of the first information and the second information in relation to the content of the payload of the biological data unit. In one embodiment processing is carried out at each network node 510 with respect to biological data units including a first header associated with information relating to a first-layer representation of biological sequence data and a second header associated with information relating to a second-layer representation of biological sequence data wherein a biological, clinical, pharmacological, medical or other such relationship exists between the first-layer and second-layer representations. For example, the DNA sequence for a gene may be related to the cDNA or RNA sequence of that gene or the protein sequence, structure or function of the gene product. In one embodiment all of the data contained within a layered representation of the DNA sequence information (see FIG. 2) would be available for a subset of patients at each client server.

As may be appreciated with reference to FIG. 2, a biological data unit predicated upon the layered data model of FIG. 2 includes a transformed representation of a biological sequence and a first header associated with first information relating to such sequence. Since the headers included within such a biological data unit may generally correspond to the layers of the layered data structure of FIG. 2, it should be understood that a processing node 510 that operates on a given layer of data will typically be able to access only a certain type of data. For example, in one embodiment “layer 1” headers are associated with the DNA layer and a network node 510 configured for “layer 1” processing would access DNA-related data.

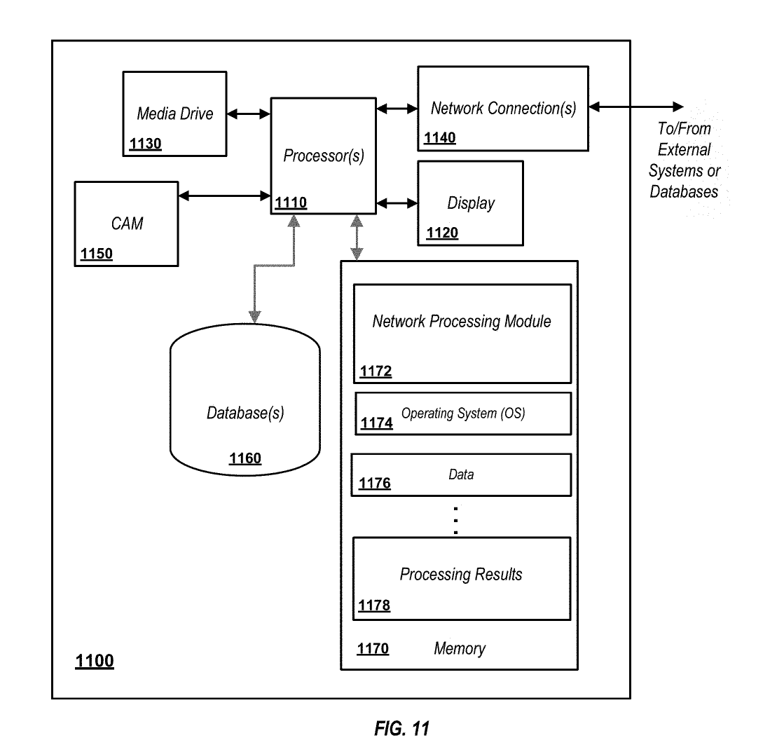

Attention is now directed to FIG. 11, which provides a representation of an exemplary processing platform 1100 capable of being configured to implement a network node 510. The processing platform 1100 includes one or more processors 1110, along with a memory space 1170, which may include one or more physical memory devices, and may include peripherals such as a display 1120, user input output, such as mice, keyboards, etc (not shown), one or more media drives 1130, as well as other devices used in conjunction with computer systems (not shown for purposes of clarity).

The platform 1100 may further include a CAM memory device 1150, which is configured for very high speed data location by accessing content in the memory rather than addresses as is done in traditional memories. In addition, one or more database 1160 may be included to store data such as compressed or uncompressed biological sequences, dictionary information, metadata or other data or information, such as computer files. Database 1160 may be implemented in whole or in part in CAM memory 1150 or may be in one or more separate physical memory devices.

The platform 1100 may also include one or more network connections 1140 configured to send or receive biological data, sequences, instruction sets, or other data or information from other databases or computer systems. The network connection 1140 may allow users to receive uncompressed or compressed biological sequences from others as well as send uncompressed or compressed sequences. Network connection 1140 may include wired or wireless networks, such as Etherlan networks, T1 networks, 802.11 or 802.15 networks, cellular, LTE or other wireless networks, or other networking technologies are known or developed in the art.

Memory space 1170 may be configured to store data as well as instructions for execution on processor(s) 1110 to implement the methods described herein. In particular, memory space 1170 may include a network processing module 1172 for performing networked-based processing functions as described herein. Memory space 1170 may further include an operating system (OS) module 1174, a data module 1176 configured to temporarily store sequence data and/or associated attributes or metadata, a module 1178 for storing results of the processing effected by the network processing module 1172.

The various modules included within memory space 1170 may be combined or integrated, in whole or in part, in various implementations. In some implementations, the functionality shown in FIG. 11 may be incorporated, in whole or in part, in one or more special purpose processor chips or other integrated circuit devices.

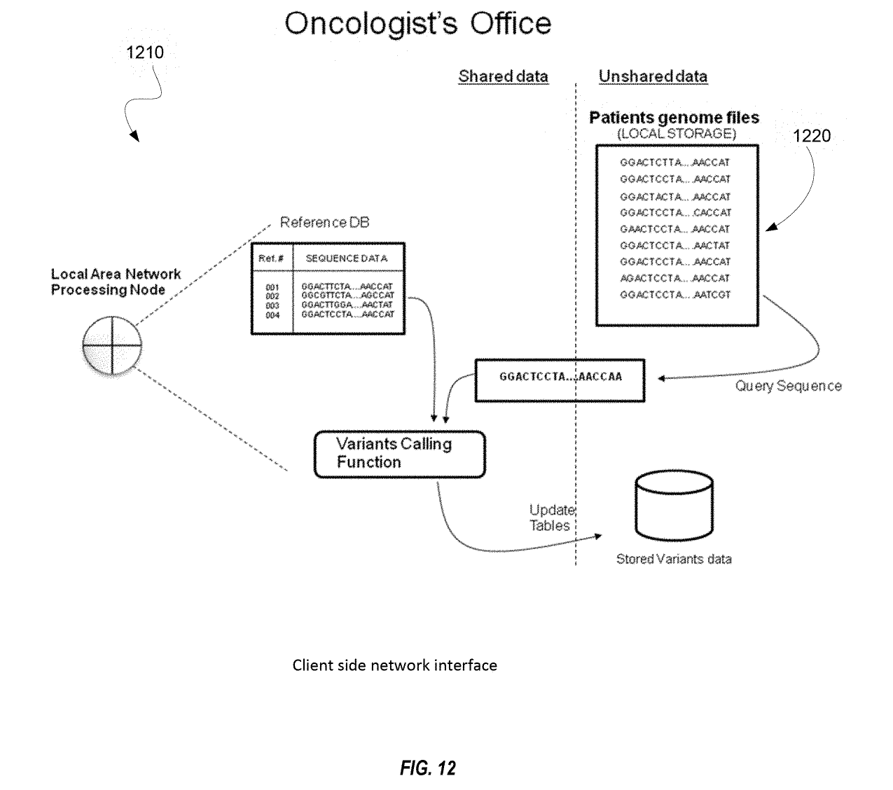

Attention is now directed to FIG. 12, which illustrates one manner in which data may be processed, managed and stored at an individual network node 510 in an exemplary clinical environment. In particular, FIG. 12 depicts one way in which the information technology systems of a medical provider (e.g., an oncologist) could interface with network processing at a node 1210 included within a local area network in communication with the data network 500. In one embodiment the network processing node 1210 may have similar or identical processing functionality as the nodes 510 of the network 500 and would be in communication with at least one such node 510, but could also be locally networked with other information technology infrastructure in a campus environment not part of the network 500.

In one embodiment none of the data which is stored in the local storage container 1220 is generally accessible to clients 560 of the network 500. Movement of data between storage containers associated with or accessible to different network nodes 510 may be governed by the policies established by the one or more clients 560 controlling such containers. For example, depending on the policy in place at a first network node 510, certain aspects of actual patient data or a transformed version of such data might be “pulled” in whole or in part from data containers accessible to a second network node 510.

### BioIntelligence Access to Existing Knowledge

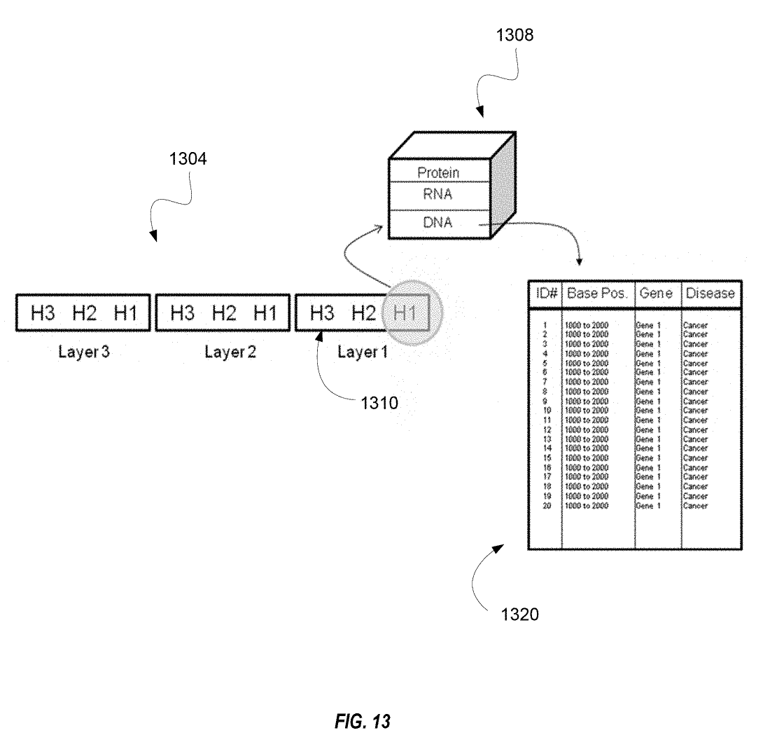

Attention is now directed to FIGS. 13-18, which illustratively represent the manner in which information within the layered data structure 200 is utilized at an individual network processing node 510. In particular, each of FIGS. 13-18 depict an exemplary representation of the relationship between information in the BioIntelligence headers 1304 of a biological data unit associated with a query message and prior knowledge 1308 within storage accessible to the node 510 that is used in generating a response to the message. It should be understood that FIGS. 13-18 provide only one example of a set of three layers of a BI header information or metadata attributes which are directly associated with the various layers of the knowledge structure.

As may be appreciated by reference to FIGS. 13-18, the first field of information present within each BI layer header specifically relates to a first source of data and/or knowledge associated with such BI header. For example, the fields within the “layer 1” header 1310 will relate directly with a first layer of the structured knowledge data model. In this case the fields within the layer 1, or “L1” header 1310 can relate with L1 data (i.e., DNA-related data in the case of the data model 200). Consequently, information that is contained in the fields of the layer 2, or “L2”, header relate directly but not strictly with the data presented in the second layer or the RNA layer data and knowledge presented in that layer.

Referring now specifically to FIG. 13, “H1” represents a first of the BioIntelligence information within the L1 set of attributes that represent header 1310 of a given data packet. In the example of FIG. 13 the particular attributes within section L1 header 1310 directly correspond to characteristics of the first layer (i.e., the DNA layer 210) of the layered model of existing related knowledge 200.

It should be noted that FIG. 13 depicts only the different layers of headers and the various header information fields, and not any associated payload of segmented sequence data, of a particular biological data unit. As discussed above, IP packets based upon a particular biological data unit which is exchanged between network nodes 510 may or may not include such payload data (i.e., such IP packets may only include higher level abstracted attribute information corresponding to the biological data unit).

In the embodiment of FIG. 13, the header field H1 within the L1 header 1310 relates to a particular type of information pertinent to the DNA layer 210. For example, as indicated by DNA-layer table 1320 maintained by the individual network processing node 510, the field H1 within the L1 header 1310 may point to the base positions for a sequence of genomic data within the payload of the biological data unit containing headers 1304. The layered prior knowledge that is being accessed or related or pointed to by BioIntelligence attributes such as H1 is specifically associated with DNA layer information of data 1308.

The segmented sequence data within the payload of the biological data unit identified by the field H1 within the L1 header 1310 may represent a certain region of a genome that may be positioned in similar but not necessarily identical base positions. For example, the comparison of this region or section of the genome that is represented in the payload for a particular gene would be expected to code for the same genes or at least different isoforms of the same gene.

As a result, the effect of L1H1 header field (layer 1, header field 1) from the stored DNA data would give comparable results for the various DNA layer annotations that are present in that data container. Such DNA layer information could include, for example, gene ID, chromosome, base positions, regulatory regions, 5′ and 3′ UTR, variant alleles and other DNA-based information related to the gene. Based on the query message, the individual network processing node 510 accesses information within data cubical of prior knowledge 1308 relating to, for example, chromosome number (for simplicity, not shown) and base positions identified by the L1H1 header field.

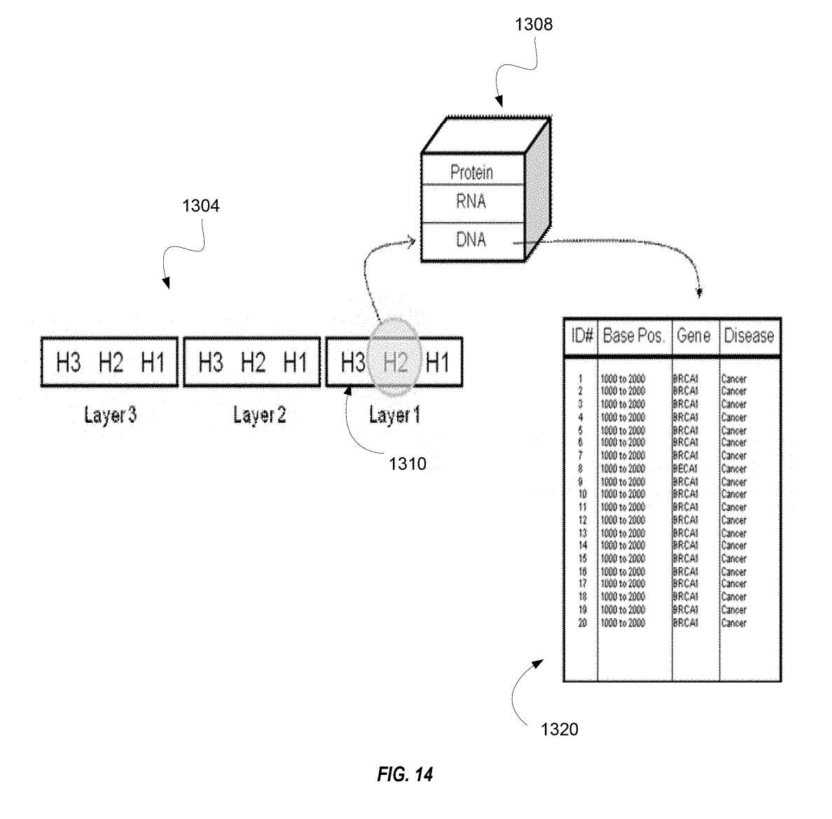

Referring now to FIG. 14, “H2” represents a second attribute of BioIntelligence header information within the L1 header 1310 of the certain data packet (i.e., the “L1H2” header field). In this case, the L1H2 header field refers to a second field in the DNA layer that points specifically to the associated gene or gene product related to the packetized segment of DNA sequence data within the biological data unit associated with headers 1304. Such sequence data could, for example, code for one gene, a plurality of genes or a part of a gene (represented in either the + or − orientation based on the 5′ to 3′ direction of the sense strand). As indicated by FIG. 14, the L1H2 attribute field relates or points to the gene ID section of the distributed network-accessible data 1308.

In one embodiment this field should contain at least one representation for the name of the gene and or gene product that is encoded by the DNA sequence in the payload of the biological data unit associated with headers 1304. In cases where more than one name is used to identify a gene, gene product or the activity associated with that gene the most current and widely accepted names are listed. Any gene ID name that is used to relate specifically to the sequence represented by the chromosome number and base positions that are indicated in the first header field of the layer 1 should be encoded by this particular sequence in this region of the genome. However, because of gene duplication, copy number variations, existence of gene families, repeat sequences, mobile transposable elements and other such related molecular phenomena certain classes of redundancy will exist. Furthermore, one gene or the polypeptide product of a gene or the enzymatic activity of a gene could be associated with more than one disease, syndrome, disorder, phenotype, etc.

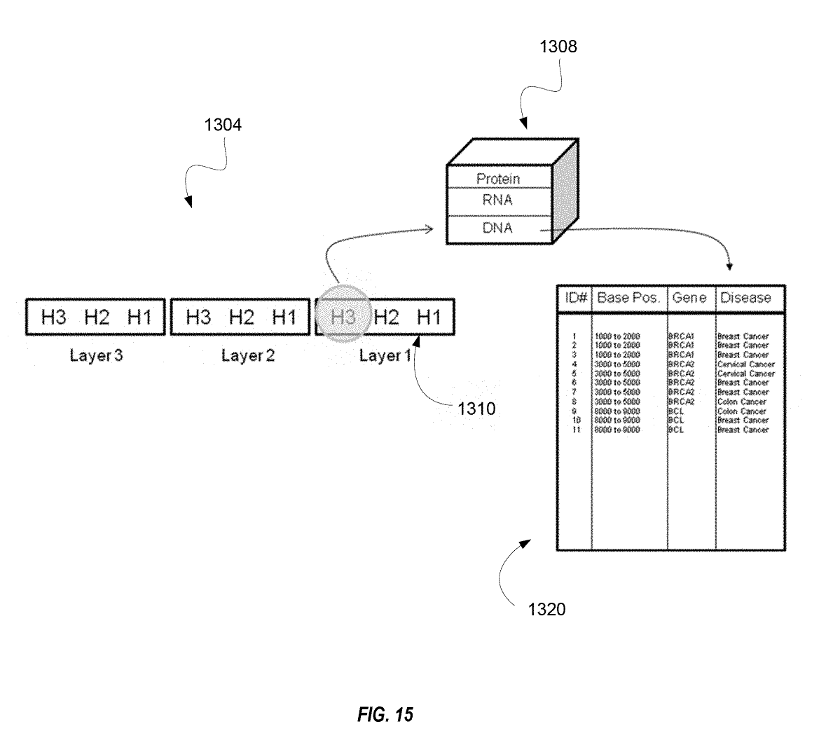

Turning now to FIG. 15, “H3” represents a third field of header information within the L1 header 1310 of the certain data packet (i.e., the “L1H3” header field). In this case, the L1H3 header field relates to any phenotypic expression of encoded gene that is associated with a disease or disorder. That is, in the example of FIG. 15 the L1H3” header field points to disease(s) known or predicted to be associated with the gene, a mutated or variant form of the gene, or an expressed gene product.

For simplicity and clarity, the supportive data in this case show three different cancer types that are associated with packaged genome sequence data attached to the exemplary header fields. The diseases that are known to have association with the segmented sequence in the payload of this biological data unit in this case are colon, cervical and breast cancers. The gene or sequence segment might represent an up-regulated oncogene or proto-oncogene, a down-regulated tumor suppressor gene or a structural or functional gene involved in a pathway with other genes associated with the disease.

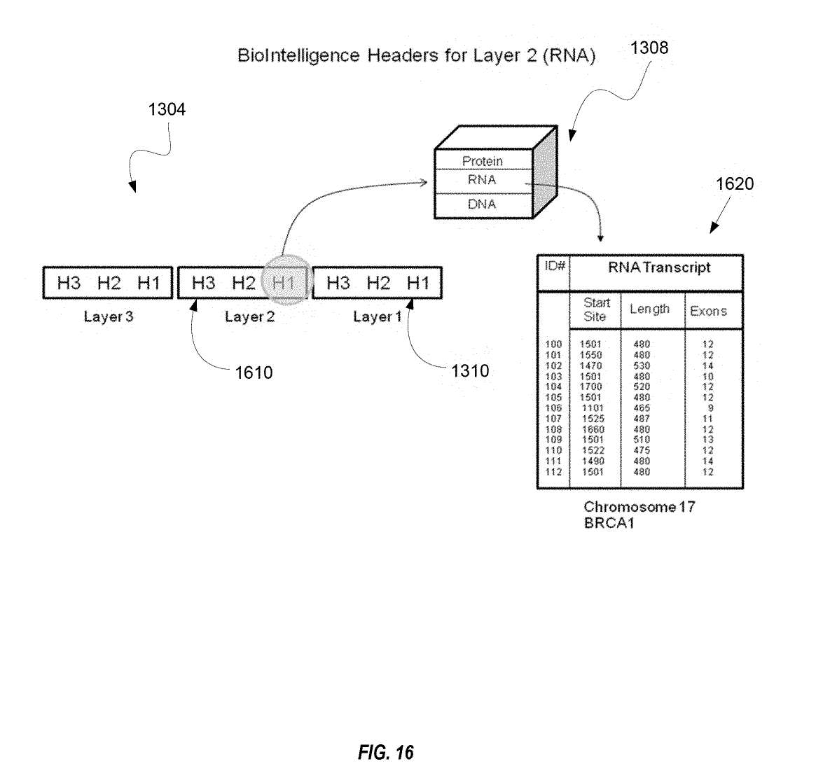

Referring now to FIG. 16, a first field of information within the L2 header 1610 of the certain data packet is denoted by “H1”. In the example of FIG. 16 the header fields within the L2 header 1610 directly correspond to characteristics of the second layer (i.e., the RNA layer 210) of the layered data model 200. It should be appreciated that network access to the data that relates to the diseases associated with any packetized segment of DNA sequence data will be through a layer 1 (DNA layer) access. Access to data associated with other layers, e.g., layer 2 and layer 3, will require access to information associated with the header fields of layer 2 or layer 3. That is, the header fields associated with the L1 header 1310 will generally relate only to data in the DNA layer 210 of the layered data structure 200, the header fields within the L2 header 1610 will relate only to data within the RNA layer 220, and so on. Such RNA-layer data related to a gene of interest could include, for example, the lengths of the pre-mRNA and mature mRNA, exon selection, alternate splicing, data on differential expression of RNA, transcription control and any RNA-related information.

As shown in FIG. 16, fields within the L2 header 1610 relate to the RNA layer 220 of the layered data structure 200. For example, in the embodiment of FIG. 16 the H1 field may relate to the transcription start site of the mRNA for the gene identified by fields of the L1 header 1310. In other words, the transcription start site information included within the RNA layer 220 would relate to the chromosomal position of the gene. It should be understood that all of the information and field data in FIG. 16 is exemplary, and none of such information actually relates to any information concerning any particular gene. For instance, where BRCA1 might be used to indicate a gene and chromosome 17 the chromosome, all of the information in the related table 1620 is exemplary. Thus, information within the RNA layer 220 and the DNA layer 210 are associated and interrelated by layered data structure 200 in a manner that allows independent access to the different information and or data types or layers.

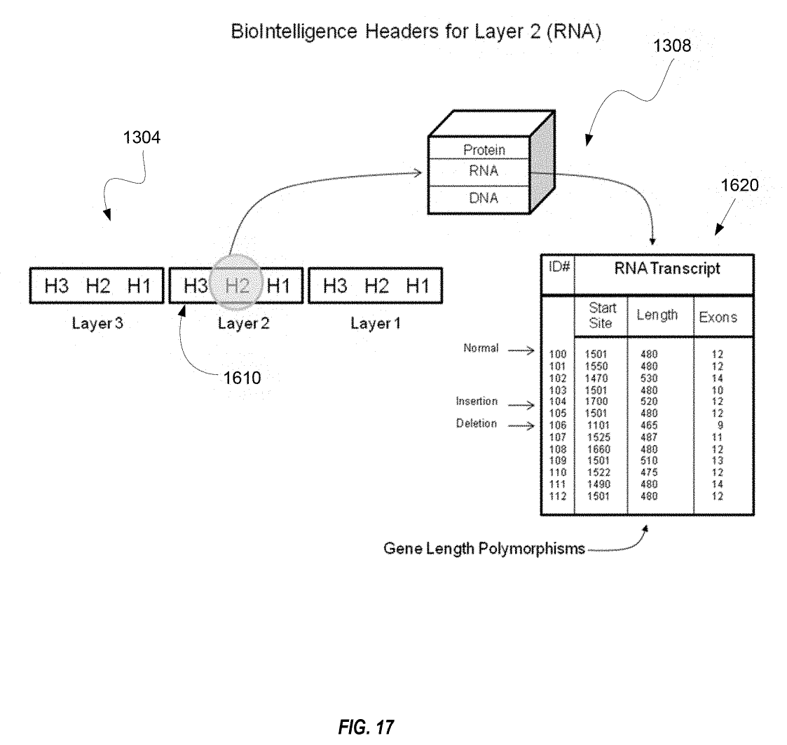

Attention is now directed to FIG. 17, in which “H2” represents a second field of header information within the L2 header 1610 of the certain data packet (i.e., the “L2H2” header field). In this case, the L2H2 header field relates to RNA-layer information pertaining to the length of a transcript. The RNA data on this particular gene shows a variety of lengths for the transcript. Entries that harbor an insertion show relatively longer transcript length; conversely, the shorter length transcripts show deleted bases in comparison with the normal case.

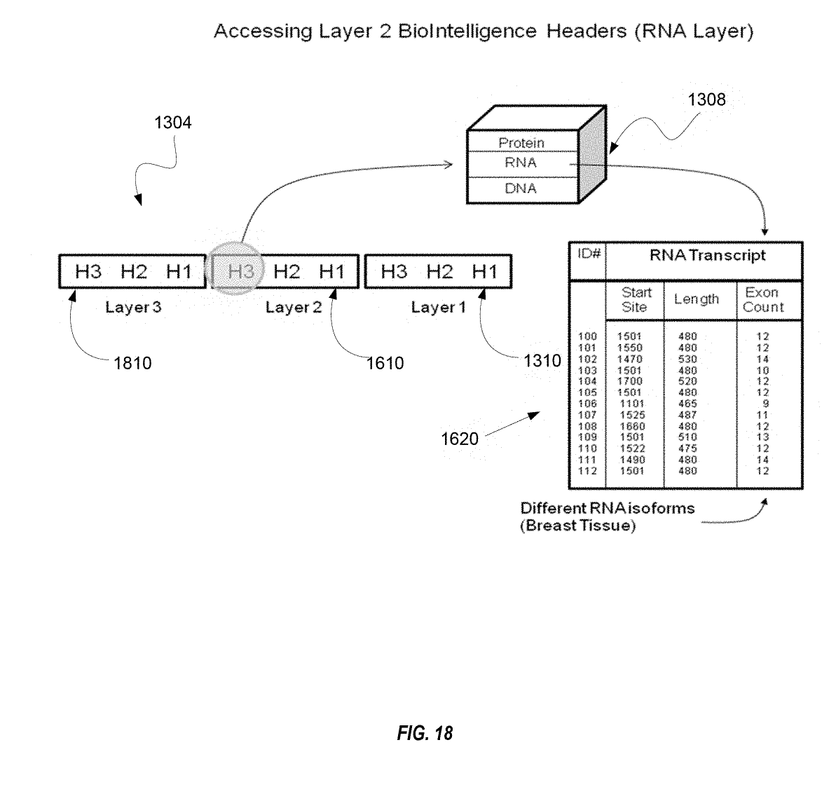

Referring now to FIG. 18, the third field (“H3”) of header information within the L2 header 1610 may relate to other information associated with the RNA layer 220. For example, this “H3L2” header field may relate to the exon selection of a gene associated with breast cancer.

In this example, the variations in the number of exons that are contained in this gene indicate the existence of different splice variants that are associated with the transcripts from cell taken from the breast tumor tissue. The defect in splicing could be from variants of the gene or some component of the splicing mechanism.

In the embodiment of FIG. 18, layer 3 (“L3”) headers 1810 may include information associated with a protein layer of the data model 200. Such protein-layer information may include, for example, the molecular weight of the protein product of the gene identified by the L1 header 1310, amino acid count and content, expression level, activity, posttranslational modifications, structure, function and other related information.

Although FIG. 18 does not explicitly depict the relationship between the fields of the L3 header 1810 and corresponding portions of the data cubical 1308, such fields are related to the protein-layer data within cubical 1308 in a manner consistent with that described above with respect to DNA-layer and RNA-layer information.

### Aggregating Biological Data Units and Associated Information Scripts Using BioIntelligence

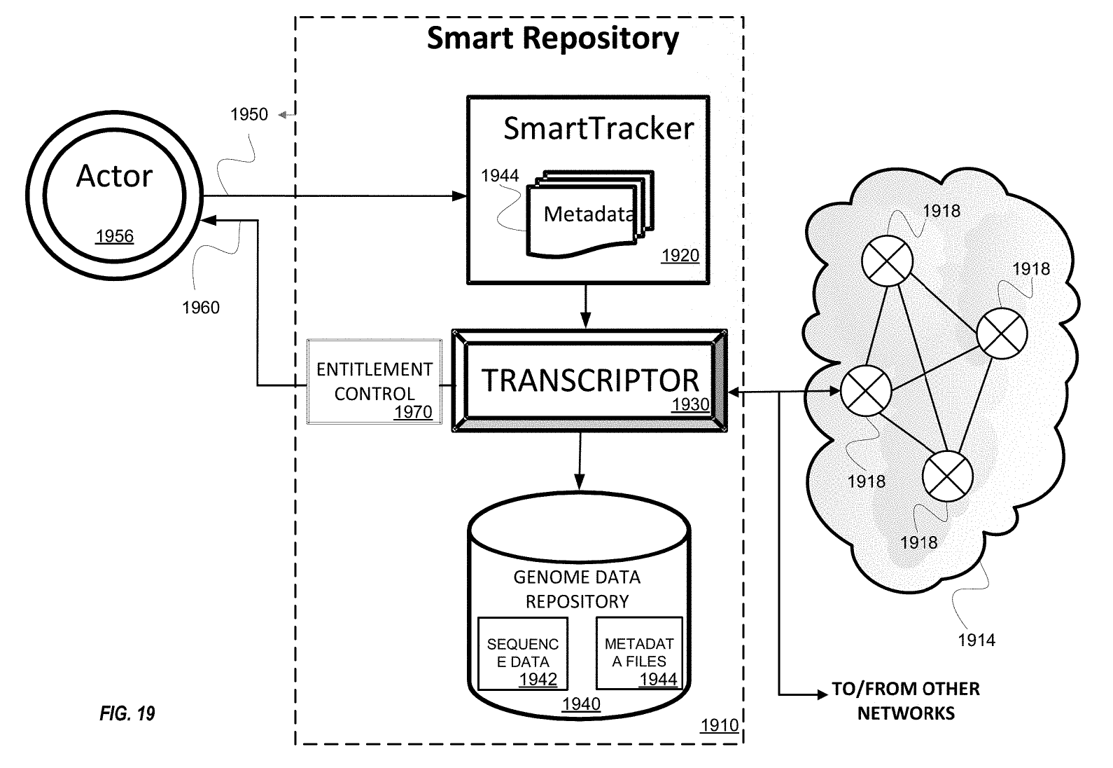

Attention is now directed to FIG. 19, which depicts a Smart Repository™ data repository 1910 configured to retrieve and aggregate genomic-related and other data relevant to the interests of actors interacting with the Smart Repository™ data repository 1910. In one embodiment the Smart Repository™ data repository 1910 may collect and provide information relevant to, but different from, information explicitly requested within queries received at the Smart Repository™ data repository 1910 from such actors. Such data may comprise, for example, clinical and/or research data pertinent to a received query that is tailored to interests of a requesting actor. In other embodiments the Smart Repository™ data repository 1910 may infer the interests of such actors based upon the sequence-related information uploaded or downloaded by such actors to and from the Smart Repository™ data repository 1910. Based upon such inferred interests of a given actor the Smart Repository™ data repository 1910 may then, either in connection with such uploading/downloading activities of the actor or otherwise, retrieve and aggregate such genomic-related and/or other data and provide the aggregated information to the actor.

In one embodiment the Smart Repository™ data repository 1910 comprises a node of, or is in network communication with, a biological data network 1914 containing a plurality of other nodes data repository 1918 and/or is in communication with other data networks, such as the Internet. In such embodiment the Smart Repository™ data repository 1910 may be, except with regard to the information aggregation functionality described below, functionally and architecturally similar or identical to the network nodes 510 described above. In other embodiments the Smart Repository™ data repository 1910 is configured to perform only the information aggregation functions described hereinafter and is not otherwise configured for networked-based processing of sequence-related information. In still other embodiments the Smart Repository™ data repository 1910 is not included within a biological data network but has access to information within other networks, such as the Internet.

As shown in FIG. 19, the Smart Repository™ data repository 1910 includes a SmartTracker™ module 1920 and a transcriptor 1930. The Smart Repository™ data repository node 1910 also includes or has access to a genome data repository 1940 containing, for example, metadata files relating to sequence information stored within the repository 1940 or elsewhere in the biological data network in which the Smart Repository™ data repository 1910 is included. Finally, the Smart Repository™ data repository 1910 may have access to other clinical or research data stored elsewhere in the biological data network 1914 or within other data networks in communication with the biological data network 1914.

In one embodiment the transcriptor 1930 operates to substantially continuously monitor the biological data network 1914 and such other data networks for information of potential relevance to users of the Smart Repository™ data repository 1910. Certain of such information may then be retrieved by the Smart Repository™ data repository 1910 and cached within the genome data repository 1940. For example, the transcriptor 1930 may collect drug efficacy and other information relating to sequence data stored within the repository 1940 which contains various biomarkers and is associated with particular disease conditions. Such information may be relatively detailed and comprehensive. For example, information relating to drug efficacy may include a “confidence” score associated with the information; that is, an indication of the level of confidence associated with the efficacy information. A high confidence score could be assigned to drugs for which relatively large amounts of patient data are available to confirm the reported efficacy, while relatively lower confidence scores could be assigned in the absence of extensive corroboration patient data.

In a first mode of operation, the SmartTracker™ module 1920 receives a query 1950 from an actor 1956 in the form of, for example, a client computer similar or identical to the client terminal 560. In one embodiment the SmartTracker™ module 1920 is, among other things, configured to track the uploading and downloading of sequence-related information occurring between the actor 1956 and the Smart Repository™ data repository 1910. In one embodiment the transcriptor 1930 assembles, based upon the subject matter of the query 1950, the sequence-related upload and/or download activity of the requesting actor and/or other aspects of the actor's profile, a script of information of various different types determined to be of relevance to the query in view of the interests of the requesting actor. This assembling may include, for example, parsing fields of the metadata files 1944 associated with files of sequence data 1942 determined to be relevant to a query 1950 in order to identify clinical and/or biological information related to the query. Once such clinical and/or biological information has been identified, its relevance may be quantified and ranked and a script 1960 containing such information is provided to the requesting actor 1956. In one embodiment the script 1960 may also be locally cached within the genome data repository 1940 and provided to other actors (not shown) which the SmartTracker™ module 1920 presently or subsequently determines possess interests similar to the requesting actor 1956. In other embodiments the script 1960 may be aggregated with other information scripts cached within the genome data repository 1940. These aggregated scripts may then be combined with other relevant information for inclusion within scripts of information subsequently generated by the transcriptor 1930 in response to subsequent requests for genomic-related information received by the Smart Repository™ data repository 1910.

In a second mode of operation, the SmartTracker™ module 1920 tracks the uploading and downloading activity of sequence-related information occurring between the actor 1956 and the Smart Repository™ data repository 1910 and instructs the transcriptor to assemble a script of related information based upon one or more aspects of this activity. The resultant script of related information may then be provided by the transcriptor 1960 to the actor 1956 in connection with an uploading or downloading transaction initiated by the actor 1956. In one embodiment the contents of this script of related information is not necessarily pertinent to specific information included within a particular request from a requesting actor, but rather is selected by the transcriptor 1960 based upon the uploading/downloading activity and/or other system usage of the actor 1956.

In one embodiment the sequence data and BioIntelligence information assembled by the transcriptor 1960 in response to a request from an actor is provided to such actor through an entitlement control module 1970. For example, an authenticated actor can query the repository for a list of all the genome data files of individuals with colorectal cancer that were uploaded within the current year by the actor 1956 or other actors (not shown). Such a query would return a complete list of the files. However, in one embodiment the actor 1956 would be permitted to access only those files within the list which the entitlement control module 1970 determines the actor 1956 is authorized to access. For example, in certain embodiments only the owners of a subset of the listed genome data files may have consented to permit the actor 1956 to download or otherwise access such files. In embodiments in which the actor 1956 subscribes to services offered by the Smart Repository™ data repository 1910 and/or biological data network 1914, the entitlement control module 1970 could be further configured to determine whether or not the requesting actor 1956 has a current subscription and, if so, the level or “quality of service” associated with the subscription. For example, in embodiments in which the actor 1956 has subscribed to a relatively higher quality of service, the information within the script provided by the transcriptor 1960 may be more recent or drawn from a wider variety of sources than would be the case had the actor 1956 opted for a lower quality of service.

In one embodiment the transcriptor 1930 may track attribute information located in the fields of the metadata files 1944 or BioIntelligence headers associated with the genomic sequence data files 1942. The information contained in the metadata files 1944 may be of any pertinent type including, without limitation, health record, image, clinical, pharmacological, medical, environmental and social data.

In certain embodiments the genome sequence data files 1942 may comprise disease-normal matched pair genomic sequence data (i.e., genomic sequence data associated with diseased tissue and “matched” genomic sequence data associated with normal tissue from the same individual). In this embodiment the Smart Tracker™ 1920 may track metadata attributes containing higher-order information with research and clinical relevance and instruct the transcriptor 1930 to include this type of information within the metadata files 1944. For example, the metadata files 1944 may contain annotation and attribute information such as, without limitation, germline and somatic genome variants, CNV data, methylation sequence data, microbiome, metabolome, transcriptome, proteome and any other related structure, function and genetic data.

The functionality of the transcriptor 1930 may be determined at least in part by the type of information incorporated into the metadata files 1944. For example, in metadata files 1944 containing transcriptome-related information, the transcriptor 1930 may be configured to aggregate data such a microRNA-Seq, mRNA-Seq and any other transcriptomic information of or pertaining to alternative splicing, differential expression and regulation.

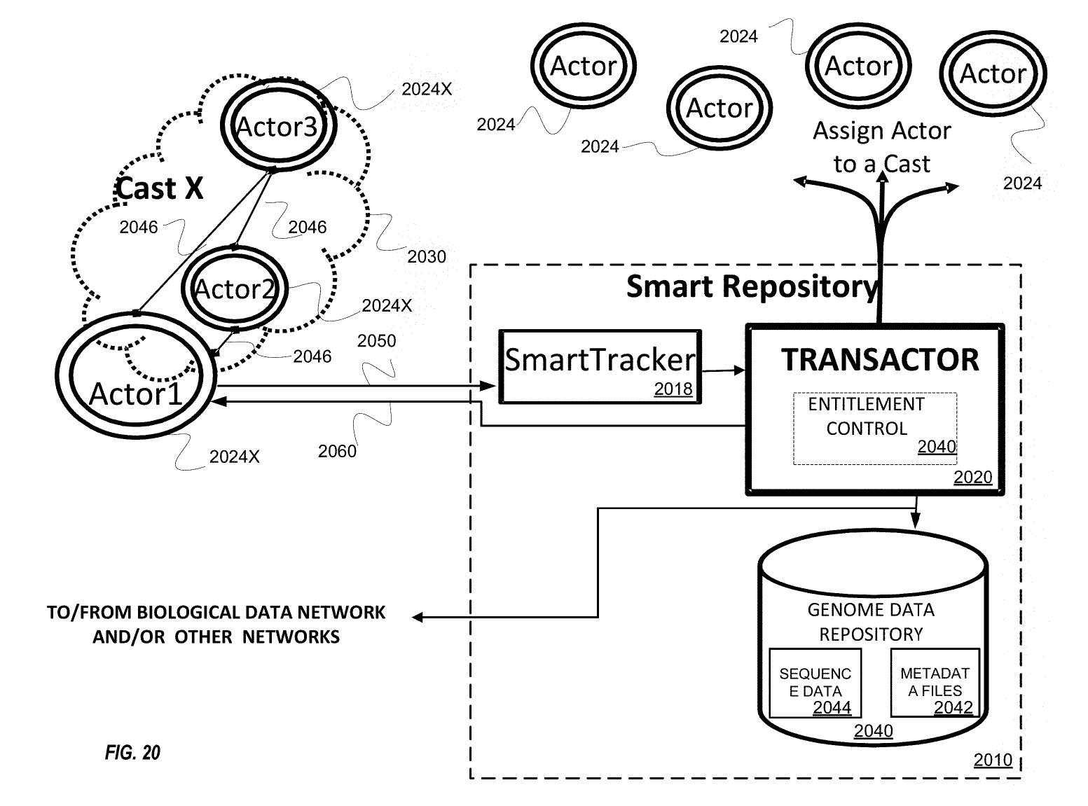

Attention is now directed to FIG. 20, which depicts a Smart Repository™ data repository 2010 which includes a SmartTracker™ module 2018 and a transactor 2020. In the embodiment of FIG. 20, the transactor 2020 operates to assign actors 2024 disposed to interact with the Smart Repository™ data repository 2010 to various “casts” of actors based upon the interaction between the various actors 2024 and the Smart Repository™ data repository 2010. The Smart Repository™ data repository 2010 is substantially similar to the Smart Repository™ data repository 1910 (FIG. 19), and includes a genome data repository 2040 containing, for example, metadata files 2042 relating to sequence information files 2044 stored within the repository 2040 or elsewhere in the biological data network (not shown) in which the Smart Repository™ data repository 2010 is included. The Smart Repository™ data repository 1910 may also have access to other clinical or research data stored elsewhere in such biological data network or within other data networks.

As shown in FIG. 20, the SmartTracker™ module 2018 may receive a query 2150 from an actor 2024X comprised of, for example, a client computer. In one embodiment the SmartTracker™ module 2018 is, among other things, configured to track the uploading and downloading of sequence-related information occurring between the actor 2024X and the Smart Repository™ data repository 2010.

In general, the transactor 2020 functions to monitor such interaction based upon information provided by the SmartTracker™ module 2018 and assign actors 2024 exhibiting similar behavior to the same cast of actors. For example, actors 2024 tending to download, from the Smart Repository™ data repository 2010, similar segments of genomic sequence data or other information could be grouped by the transactor 2020 into the same Cast X 2030 comprised of actors 2024X.

As is described in the above-referenced provisional application Ser. No. 61/539,942, grouping of the actors 2024X into a common Cast X 2030 enables large files of sequence data 2044 and other information to be downloaded by such actors 2024X using a genomic sequence transfer protocol designed to more efficiently utilize the network bandwidth available to the Smart Repository™ data repository 2010. The disclosed genomic sequence transfer protocol provides a method for secure, high-speed file transfer which is capable of overcoming the disadvantages of TCP and existing peer-to-peer protocols with respect to the distribution of files of very large size. Like other peer-to-peer file distribution systems, the disclosed high-speed file transfer system disclosed in the above-referenced provisional application utilizes a tracker (e.g., the SmartTracker™ 1920) to enable a plurality of actors 2024X within the CastX 2030 to cooperatively distribute a file of interest. Within the context of the genomic sequence transfer protocol, the transactor 2020 operates to identify and make a record of those Actors 2024 which request a certain file of interest (e.g., “file X”). The transactor 2024 will also generally include or be paired with an entitlement control module 2040 configured to determine the authentication and entitlement of each actor based on authorization rules and using a secure key distribution scheme.

In one embodiment the transactor 2020 may determine which actors 2024 are assigned to a particular cast (e.g., Cast X 2030) based upon, for example, the file requested, the location of the file (i.e., with which actor(s) 2024 the file is currently stored), as well as the credentials of the actors 2024 requesting access to the file. Once an actor 2024 has been directed to a particular cast, the actor 2024 exchanges messages 2046 with other actors 2024 within the cast in order to determine and receive the portions of the file of interest currently possessed by the Cast X 2030. Stated differently, the transactor 2020 proactively directs a requesting leecher actor to a feeder affinity group such that the leecher receives as much of the requested file as possible without, to the extent possible, incrementing the burden on the seed of file X.

In the case of very large files, such as files containing genomic or other biological sequence information, the disclosed genomic sequence transfer approach effectively “parallelizes” the transfer of file information and reduces the burden on the initial seed or seeds of file X. Moreover, the use of parallel streams within the disclosed system minimizes the effect of a multiplicative decrease in the speed of any one stream resulting from the characteristics of TCP. Thus, use of the disclosed genomic sequence transfer protocol may reduce the likelihood of bottlenecks developing around overburdened seed servers in connection with the transfer of very large data files.

The use of such parallel streams also enables the separate encryption of each individual file segment, thus obviating the need for re-encryption and retransmission of the entire file in the event of corruption of an individual segment. Particularly in the case of very large data files containing sensitive information (e.g., files containing genomic sequence information), this aspect of the disclosed genomic sequence transfer protocol may offer considerable advantages relative to existing methods of file distribution.

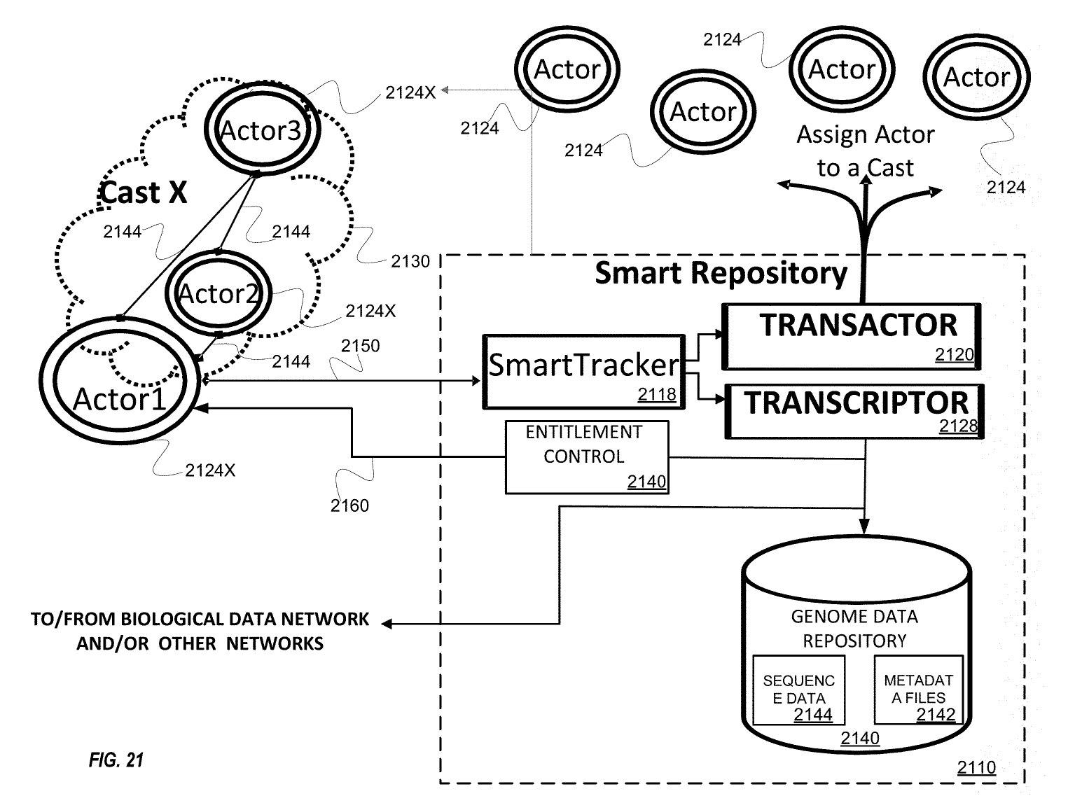

Turning now to FIG. 21, there is illustrated an implementation of a Smart Repository™ data repository 2110 which includes a SmartTracker™ module 2118, a transactor 2120 and a transcriptor 2128. Except to the extent described otherwise below, the transactor 2120 functions in a substantially identical fashion as the transactor 2010 (FIG. 20) and the transcriptor 2128 functions substantially identically to the transcriptor 1930 (FIG. 19). For example, during operation the transactor 2120 assigns actors 2124 disposed to interact with the Smart Repository™ data repository 2010 to various casts based upon information provided by the SmartTracker™ module 2118 relating to the interaction between the various actors 2124 and the Smart Repository™ data repository 2110. The Smart Repository™ data repository 2110 also includes a genome data repository 2140 containing, for example, metadata files 2142 relating to files of sequence information 2144 stored within the repository 2140 or elsewhere in the biological data network (not shown) in which the Smart Repository™ data repository 2010 is included. The Smart Repository™ data repository 2110 may also have access to other clinical or research data stored elsewhere in such biological data network or within other data networks.

In one embodiment, the transcriptor 2128 will use the metadata collected by the SmartTracker™ module 2118 and stored in the metadata files 2142 of the genome data repository 2140 to form an aggregated script of associated information. Based on classification schemes which may be continuously updated and curation of such information within the metadata files 2142 by, for example, subject matter experts, the transcriptor 2128 assemble one or more scripts 2160 of stratified, highly-relevant clinical and research data. This assembling may include, for example, parsing fields of the metadata files 2142 associated with sequence data files 2144 determined to be relevant to a query 2150 in order to identify clinical and/or biological information related to the query 2050. This assembling may further include, for example, evaluating the sequence-related upload/download activities of the requesting actor 2142X. Once such clinical and/or biological information has been identified and such upload/download activity evaluated, the relevance of the information may be quantified and ranked and a script 2160 containing such information is provided to the requesting actor 2142X.

The Information within the metadata files 2142 will typically include one or more tags identifying the corresponding sequence data to which such information relates as well as relevant annotations and abstracted data. The information within the metadata files 2142 or BioIntelligence headers will typically include, without limitation, information from pathology reports associated with the corresponding sequence data such as, for example, gross and microscopic descriptions, diagnosis, tumor size and grade. The metadata files 2142 may also include information concerning a patient's blood report that is relevant to a given diagnosis, as well as treatment options relevant to such diagnosis. These information fields relating to such blood report will generally include, for example, red blood cell (RBC), leukocytes, platelets or thrombocytes counts, hemoglobin concentration, hematocrit measures, erythrocyte size test and mean corpuscular measures. The metadata files 2142 may also include information concerning a patient's cytology report indicating, for example, the presence or absence of atypical cells and/or malignant dysplasia.

Metadata Attributes Associated with Genome Data

Set forth below is a representative list of the type of exemplary information fields which may be included within the metadata files 2142 or otherwise stored within the genome data repository 2140 as associated BioIntelligence header information.

### Molecular Metadata Attributes

ID or UUID: Universal Unique ID corresponding to a sequence data file or to other information related to the sequence information of a sequence data file

Disease: The diseases which are associated with a sequence data file

Cell: Cell or tissue type used to prepare analyte

CNV: Relevant information on copy number variation

SV: Related structural variants and chromosomal rearrangements

SNP: SNPs associated with the diseases

microRNA: Correlated microRNA expression information

mRNA: Differential expression of associated genes

Splice: Any information on splice variants and alternative splicing

Methylation: DNA methylation, hetero chromatin and Methyl-Seq information

Pathway: Information on known or predicted pathways

Gene: Information on known or predicted genes

Activity: Molecular activities in the related pathway; kinase, methylation, phosphorylation

Regulation: Mutations in known or predicted regulatory regions

Exogenous: Relevant microbial genome information

Mobile: Information on transposable DNA elements

Repeats: Available information on any tandem or interspersed DNA repeat sequences associated with the disease

Protein: Information on body fluids protein concentration and activity

### Clinical Oncology Metadata Fields

Age:

Tumor size:

Tumor grade:Cellular differentiation

Tumor stage:

Tumor behavior:

Origin: Organ, tissue, cell

Node status: Positive or negative

Hormone receptor: Positive or negative

Laboratory procedures ordered:
DNA preparation
RNA purification
DNase treatment
PCR amplification
cDNA purification
microarray hybridization; scanning
next generation sequencing
   raw reads
   sorting
   align and Map
   calling variants
   clinical associations
   molecular associations

In one embodiment some or all of the information within the genome data repository 2140 is linked on the basis of UUIDs corresponding to ones of the sequence data files 2144. For example, consider the exemplary case in which a sample of a cancerous tumor is taken from the patient. In this case a first UUID could be assigned to the tumor sample and stored within the genome data repository 2140 in association with information relating to the tumor (e.g., size of tumor, date taken, procedures performed). This first UUID could also be linked to medical or other records associated with the patient.

Based upon tissue from the tumor sample, various analytes (e.g., DNA, RNA) may be derived and purified. Each of these purified analytes may then also be associated with a different UUID, all of which are linked to the first or primary UUID associated with the tumor sample itself. Various information relating to each such analyte (e.g., concentration of the analyte within the test tube or other analyte repository, name or other information identifying the individual responsible for preparing the analyte sample) may be stored in connection with the UUID corresponding to the analyte. An aliquot of the solution of one such purified analyte (DNA, RNA, etc.) may then be obtained, assigned a UUID linked to, for example, either or both of the UUID of the analyte solution and the first or primary UUID of the tumor sample. The aliquot may then be provided to a sequencing machine and another UUID assigned to the resultant sequence data. In addition to base-pair sequence data, such sequence data may include information relating to, for example, the machine used to perform the sequencing and the individual(s) responsible for operating such machine at the time of the sequencing. In addition, variant calls may be made with respect to such sequence information and the corresponding sequence variants may be assigned UUIDs linked to the UUID of such sequence information.

In one embodiment the Smart Repository™ data repository 2110 provides the sequence data generated by the sequencing machine to another node of a biological data network in which the Smart Repository™ data repository 2110 is included and such node performs variants call processing to determine the sequence variants corresponding to one or more portions of the sequence data and provides such sequence variants to the Smart Repository™ data repository 2110. Each of these sequence variants may then be assigned a UUID linked to the underlying sequence data and stored within the genome data repository 2140. Similarly, either the underlying sequence data or the associated sequence variants may be correlated with, for example, drug efficacy information. Such correlated information may be assigned one or more UUIDs linked to the UUIDs of the underlying sequence data and/or the sequence variants and stored within the genome data repository 2140.

As a consequence of this linked relationship among data records within the genome data repository 2140, an actor 2140X may submit a query to the repository 2140 identifying one or more UUIDs (e.g., the UUID relating to a particular tumor sample), and receive information relating to some or all of the data records associated with UUIDs linked to the identified UUID(s). The particular fields of the records within the repository 2140 which are evaluated by the transcriptor 2128 in response to a query in order to identify a relevant set of UUIDs to be returned in response to such a query will generally be dependent upon the subject matter of the query. For example, the transcriptor 2128 would evaluate attribute information from a different set of fields within the metadata files 2142, BioIntelligence headers or other records stored within the repository 2140 in response to a query relating to breast cancer than would be evaluated in response to a query relating to prostate cancer. This difference might range from particular types of sequence variants and modifications associated with certain cancers, to the pertinent clinical information that may be taken from the patient's laboratory reports.

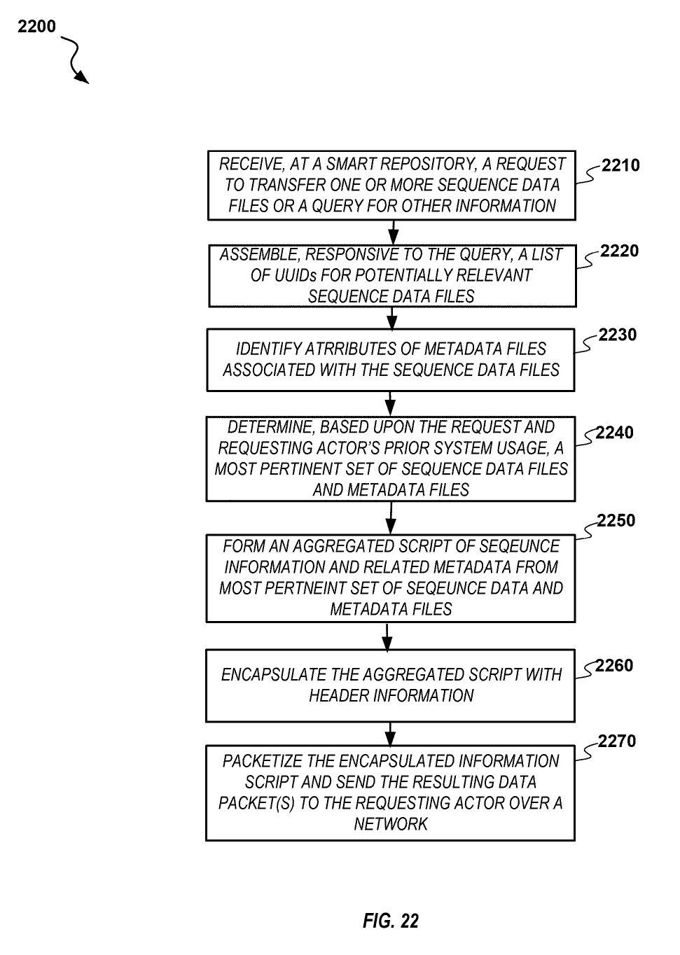

Referring to FIG. 22, there is shown a flowchart representative of exemplary interaction 2200 between an actor 2124X and the Smart Repository™ data repository 2110. In the exemplary interaction 2200 illustrated by FIG. 22, the Smart Repository™ data repository 2110 receives a request from the actor 2124X to transfer one or more sequence data files or to provide other information (stage 2210). In this embodiment the SmartTracker™ module 2118 is aware of, or may determine based upon contents of the metadata files 2142, the sequence data files 2144 potentially relevant to the query (stage 2220) and assembles the UUIDs corresponding to these files into a list. The sequence data files may be in any format including, for example, the binary alignment map (BAM) format. The SmartTracker™ module 2118 then identifies, based upon this list of UUIDs, attributes of the metadata files 2142 associated with the sequence data files previously determined to be potentially relevant to the query. In a stage 2240 the transcriptor 2128 then determines, in view of the request and the prior system usage (e.g., sequence-related upload/download activity) of the requesting actor 2124X, a most pertinent set of sequence data files 2144 and metadata files 2142. The transcriptor 2128 then works in concert with the SmartTracker™ module 2118 to form, from this most pertinent set of sequence data files 2144 and metadata files 2142, an aggregated script of sequence information and related metadata (stage 2250). The aggregated script is then encapsulated with header information (stage 2260). This encapsulated information script may then be packetized and the resulting data packet(s) sent to the requesting actor over a network (stage 2270).

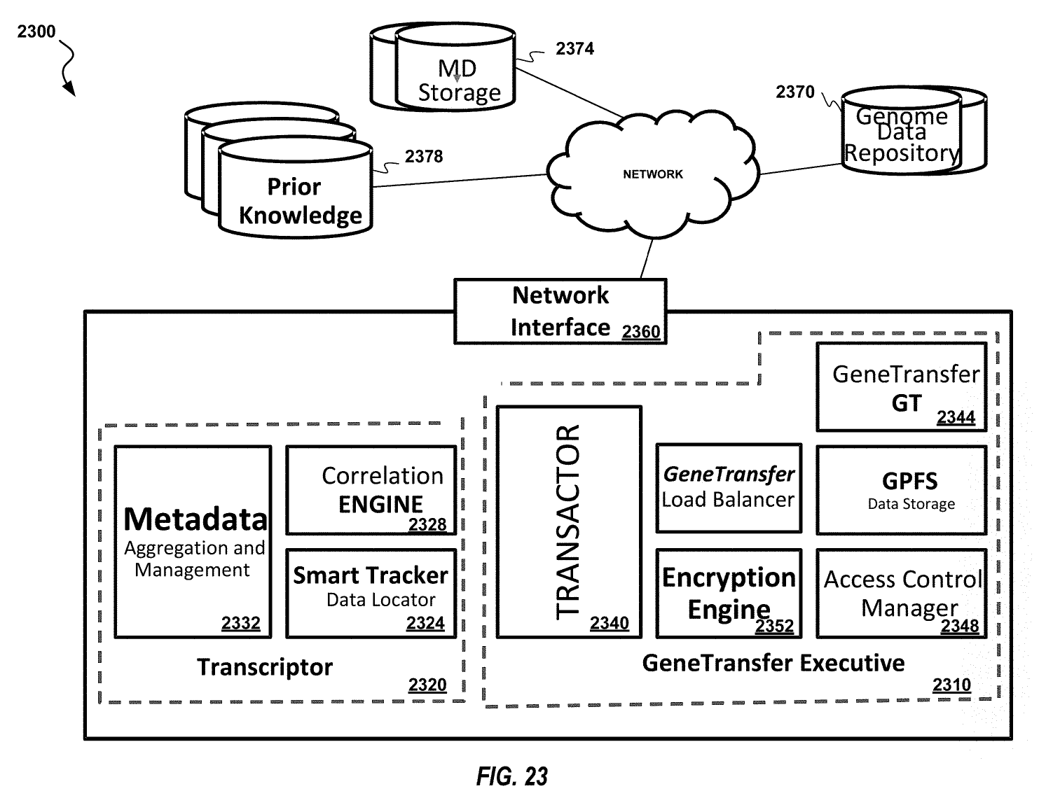

Turning now to FIG. 23, there is illustrated an alternate implementation of a Smart Repository™ data repository 2300 including a GeneTransfer Executive module 2310 and a transcriptor 2320. As shown, the transcriptor 2320 integrates a Smart Tracker™ module 2324 together with a correlation engine 2328 and a metadata module 2332. In one embodiment the metadata module 2332 is configured for aggregating and managing metadata related to queries received by the Smart Repository™ data repository 2300 in the manner described herein.

The GeneTransfer Executive module 2310 includes a transactor 2340, a GeneTransfer module 2344, access control manager 2348 and an encryption engine 2352. In one embodiment the GeneTransfer module 2344 generates packetized biological data units in the manner described herein. These packetized biological data units are then encrypted by the encryption engine 2352 prior to being sent by a network interface 2360 to a requesting client actor (not shown).

The Smart Repository™ data repository 2300 further includes a genome data repository 2370, metadata storage 2374 and a repository of prior knowledge 2378. The network interface 2360 also facilitates the transfer of genomic sequence data, metadata and prior knowledge between, on the one hand, the genome data repository 2370, metadata storage 2374 and repository of prior knowledge 2378 and, on the other hand, the GeneTransfer Executive 2310 and the transcriptor 2320.

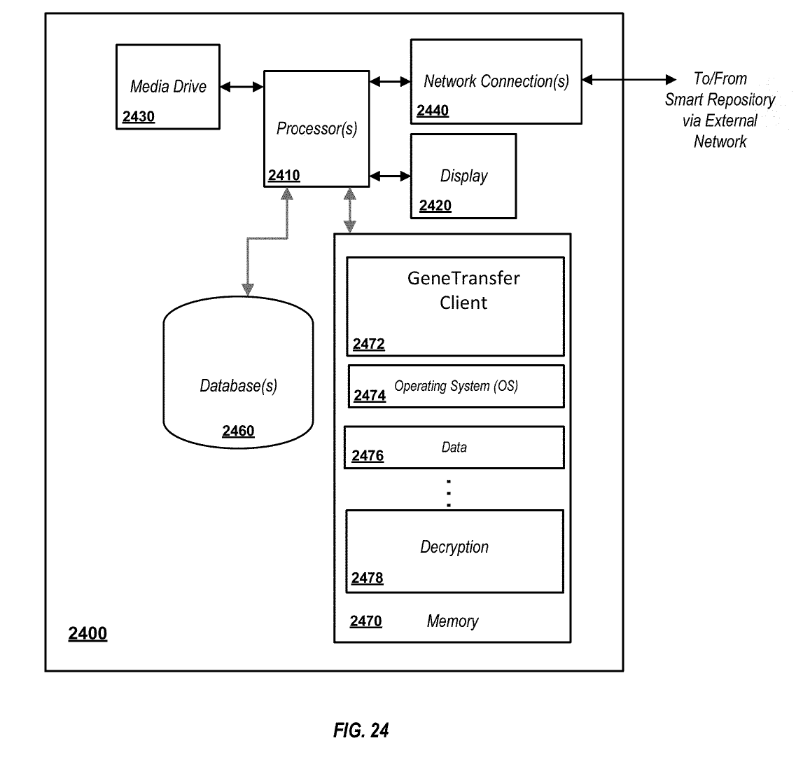

Attention is now directed to FIG. 24, which depicts an exemplary implementation of an actor 2400 configured to interact as a client with the Smart Repository™ data repository 2300 of FIG. 23. As shown, the actor 2400 includes a processor 2410 and a memory space 2470, which may include one or more physical memory devices. The actor 2400 may also include peripherals such as a display 2420, user input output, such as mice, keyboards, etc (not shown), one or more media drives 2430, as well as other devices used in conjunction with computer systems (not shown for purposes of clarity). In addition, one or more databases 2460 may be included to store data such as compressed or uncompressed biological sequences, dictionary information, metadata or other data or information, such as computer files. Database 2460 may be implemented in one or more separate physical memory devices.

The actor 2400 may also include one or more network connections 2440 configured to send or receive biological data, sequences, instruction sets, or other data or information to and from Smart Repositories or other databases or computer systems. The network connection 2440 may allow users to receive uncompressed or compressed biological sequences from, for example, the Smart Repository™ data repository 2300 as well as send uncompressed or compressed sequences. Network connection 2440 may include wired or wireless networks, such as Etherlan networks, T1 networks, 802.11 or 802.15 networks, cellular, LTE or other wireless networks, or other networking technologies are known or developed in the art.

Memory space 2470 may be configured to store data as well as instructions for execution on the processor 2470 to implement the methods described herein. In particular, memory space 2470 may include a GeneTransfer client module 2472 for transferring genomic sequence information to and from the GeneTransfer module 2344 within the Smart Repository™ data repository 2300. Memory space 2470 may further include an operating system (OS) module 2474, a data module 2476 configured to temporarily store sequence data and/or associated attributes or metadata, and a decryption module 2478 for decrypting encrypted biological data units or other encrypted information received from the Smart Repository™ data repository 2300.

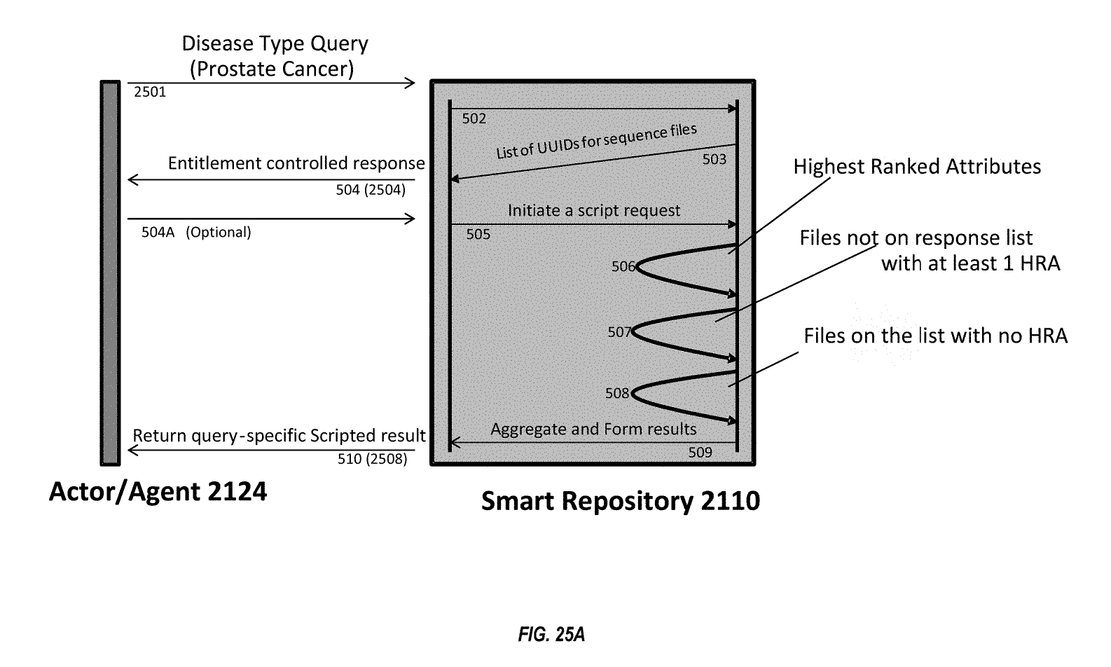

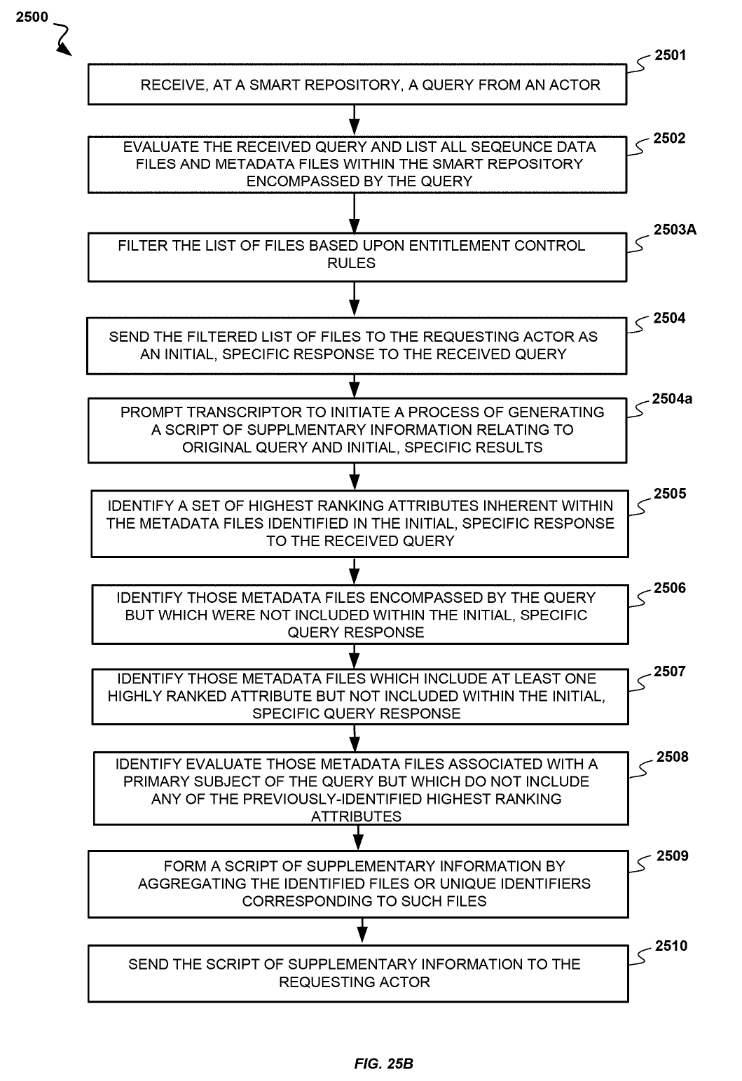

Attention is now directed to the process flow diagram of FIG. 25A and the flowchart of FIG. 25B, which collectively provide a more detailed representation of exemplary process 2500 performed by the Smart Repository™ data repository 2110 in processing a request from an actor 2124. In one embodiment the Smart Repository™ data repository 2110 generates a two-part response to each query message received from an actor 2124. In particular, the Smart Repository™ data repository 2110 may generate and send to the actor 2124 a specific entitlement-controlled response 2504 comprised of, for example, a list of the UUIDs of sequence data files 2144 and associated metadata files 2142 corresponding to the request. As is discussed in further detail below, the Smart Repository™ data repository 2110 may also generate a supplementary response 2508 comprised a script of other information determined to be relevant to the request.

The process 2500 is initiated in response to a query sent by the actor 2124 to one or Smart Repositories, such as the Smart Repository™ data repository 2110 (stage 2501). It should be understood that in certain embodiments the actor 2124 may submit requests to a single Smart Repository™ data repository, such as the Smart Repository™ data repository 2110. In such embodiments the Smart Repository™ data repository 2110 may be capable of responding to the request directly. Alternatively, the Smart Repository™ data repository 2110 may parse the request, send corresponding requests to one or more other Smart Repositories included within a biological data network accessible to the Smart Repository™ data repository 2110, and forward a response to the request to the actor 2124 based upon information included within the Smart Repository™ data repository 2110 and/or provided by such other Smart Repositories. In other embodiments the actor 2124 may send the request to a group of Smart Repositories and further process the set of results received from this group.

The query received during stage 2501 may exhibit varying degrees of specificity. For example, the query could request that the Smart Repository™ data repository 2110 return information relating to all of the whole genome sequences included within the Smart Repository™ data repository 2110 (or available within other Smart Repositories included within a biological data network in which the Smart Repository™ data repository 2110 is also included) associated with a diagnosis of prostate cancer. Somewhat more specifically, the query received during stage 2501 could request generation of a complete list of all of the genome sequence files 2144 (e.g., BAM files) and associated ancillary metadata files 2142 (e.g., XML files) that have been submitted to the Smart Repository™ data repository 2110 by a particular actor 2124 (e.g., a genome sequencing center) during a certain time frame. In this case the scripted response 2160 to the query could comprise a list of those UUIDs representative of all such genome sequence files 2144 and associated ancillary metadata files 2142.

In other cases the query received during stage 2501 may identify a particular disease type. In this regard the query could request information relating to the genome sequence files 2144 associated with tissue from individuals that have diagnosed with a certain disease type and sequenced within a particular time period at a specific sequencing center. As a specific example of this case, the query could request all sequence files generated at the Broad sequencing center based upon patients diagnosed with prostate cancer which were uploaded to a Smart Repository™ data repository within a particular biological data network between Jun. 1, 2011 and Aug. 31, 2011. In this case the expected would be a list of those UUIDs representative of all the genome sequence files and metadata files (e.g., XML files) relating to patients diagnosed with prostate cancer.

In a stage 2502, the SmartTracker™ 2118 evaluates the received query and identifies all of the sequence data files 2144 and metadata files 2142 within the Smart Repository™ data repository 2110 encompassed by such query. The SmartTracker™ 2118 may also identify all other sequence data files and metadata files accessible within any biological data network(s) in which the Smart Repository™ data repository 2110 is included that are requested by the query. In one embodiment the SmartTracker™ 2118 identifies the appropriate genome sequence data files and associated metadata files by tracking and parsing the attribute fields of such metadata files in accordance with the received query. For example, in cases in which the received query indicates an interest in sequence data files from individuals diagnosed with prostate cancer which have been uploaded to a particular sequencing center during a particular time, the SmartTracker™ module 2118 would evaluate the attribute fields of all available metadata files relating to these parameters and generate a list of UUIDs corresponding to the metadata files and the associated genome sequence data files (stage 2503).

In one embodiment the list of UUIDs generated by the SmartTracker™ module 2118 is filtered by the entitlement control module 2140 based upon, for example, patient consent, subscription parameters and the like (stage 2503A). The filtered list of UUIDs produced by the entitlement control module 2140, which comprises an initial, specific response to the query received during stage 2501, is then sent to the requesting actor 2124 (stage 2504). In other embodiments the list of UUIDs is not filtered prior to being provided to the requesting actor 2124. However, in this case the entitlement control module 2140 enforces conditional access rules when the requesting actor 2124 attempts to download the genome sequence data files or metadata files corresponding to any of the listed UUID's. That is, the requesting actor 2124 is permitted to download only those sequence-related or metadata files which the entitlement control module 2140 determines that such actor 2124 is entitled to access.

At stage 2504A, the requesting actor 2124 prompts the transcriptor 2128 to initiate a process of generating a script of supplementary information related to the subject matter of the initial, specific response provided to the requesting actor 2124 during stage 2504. In one embodiment the requesting actor 2124 automatically prompts the transcriptor 128 to initiate such process upon receiving the initial, specific response during stage 2504, provided the requesting actor 2124 has expressed a preference to receive such an information script (either as part of the request received during stage 2501 or otherwise). In other embodiments stage 2504A is initiated only after the requesting actor 2124 has received the initial, specific response during stage 2504 and subsequently explicitly requested the script of supplementary information.

In order to generate the script of supplementary information, the transcriptor 2128 evaluates the query received during stage 2501 and the initial, specific response delivered during stage 2504. Next, in a stage 2505, the transcriptor 2128 initiates a script request by commencing a process for identifying a set of highest ranking attributes (HRAs) inherent within the metadata files returned as part of the initial, specific response during stage 2504. This could involve, for example, determining the relative frequency at which various attributes appear within the metadata files returned during stage 2504. For example, if a particular attribute appears in every one of the metadata files subsequently returned during stage 2504, then such attribute would likely be included among the set of HRAs associated with the corresponding query received during stage 2501. Based upon an evaluation of, for example, the relative frequency at which various attributes appear within the metadata files returned during stage 2504, a set of HRAs may be determined by the transcriptor 2128. In certain embodiments other considerations may bear upon whether a particular attribute is included among the set of HRAs corresponding to a given query. For example, the distribution of the particular attribute information as it relates to the universally unique identifier (UUID) and the strength of the curated evidence associated with such attribute information may also be considered by the transcriptor 2128 when determining a set of HRAs.

In addition to parsing the metadata files returned during stage 2504 in order to determine a set of HRAs, during stage 2506 the transcriptor 2128 will typically also evaluate those metadata files which are generally encompassed by the query received during stage 2501 but which were not identified during stage 2503 because of other limitation or constraints present within the query. For example, in the case in which a query received during stage 2501 requests a list of sequence files associated with a diagnosis of prostate cancer which were uploaded to the Smart Repository™ data repository 2110 by a particular sequencing center during a particular time window, the transcriptor 2128 may nonetheless evaluate the attribute information included within those metadata files associated with a diagnosis of prostate cancer which are also associated with sequence information uploaded by other than the specified sequencing center and/or were uploaded outside of the particular time window. Similarly, the transcriptor may evaluate metadata files associated with a diagnosis of prostate cancer which are stored within other Smart Repositories as part of the process of determining HRAs corresponding to a particular query. In this way the set of HRAs may be determined to include attributes not otherwise known to be associated with a disease type specified within a query (e.g., prostate cancer) but which in fact are highly correlated to known cases of such disease type.

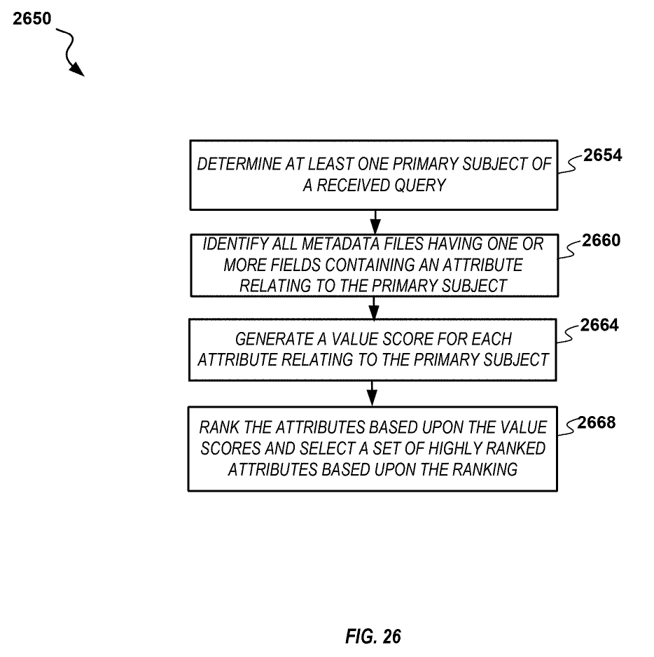

FIG. 26 is a flowchart representative of an exemplary process 2650 for ranking attributes appearing within the relevant metadata files in order to identify a set of HRAs as contemplated during stage 2606. Referring to FIG. 26, in a stage 2654 at least one primary subject (e.g., prostate cancer) of the query received in stage 2501 (FIGS. 25A and 25B) is determined. All metadata files having one or more fields relating to an attribute relating to this primary subject are then identified (stage 2660). For example, if the primary subject were determined to be “prostate cancer”, then all metadata files having the attribute of “prostate cancer” in a “disease type” field would be identified. This will typically include identifying those metadata files having one or more attributes within pertinent fields which relate to the primary subject but which were excluded from the initial, specific query response because of the presence of other filter parameters (e.g., time window during which sequence information was uploaded) within the query received during stage 2501. A value score is then generated in a stage 2664 for each field attribute of the metadata files identified during stage 2660 based on, for example, the frequency and distribution of the attribute within the identified metadata files, the strength of the curated field, and the relationship to disease diagnosis (i.e. PSA score, other screens and clinical assays) and other rank order rules. The field attributes determined to be of relevance to the primary subject are then ranked based upon these value scores and a set of HRAs are then selected based upon this ranking (stage 2668).

The HRAs may or may not be within a field identified by the query received during stage 2501. In one embodiment ranking of the attributes during stage 2668 determines which information fields and sequence data files, including those files identified in the initial, specific response to the received query, may be most relevant to the primary subject of the query received during stage 2501. For example, in the case in which the received query specifically requests a list of sequence files relating to prostate cancer, all of the sequence files identified in the initial, specific response will be associated with metadata files containing the attribute “prostate cancer” within the “disease type” field. However, there could be instances in which a specific attribute of a metadata file such as, for example, blood PSA level, could be indicated to be significantly above a concentration level associated with a high risk for prostate cancer (e.g., 4 ng/ml), but in which such metadata file does not include an attribute indicating a diagnosis of prostate cancer and the associated individual exhibits no other symptoms of prostate cancer. Accordingly, even through a query received during stage 2501 having a primary subject of “prostate cancer” may not have included “blood PSA level” as a parameter, a blood PSA level in excess of 4 ng/ml could be deemed to be an HRA with respect to such query because of its correlation with prostate cancer. As another example, there could be cases associated with individuals which have developed a prostate cancer tumor in which one attribute of a metadata file relating to fluorescence in situ hybridization (FISH) reflects a “PTEN deletion” while another such attribute indicates a normal or low PSA blood level. Such a PTEN deletion could then be determined by the transcriptor 2128 to be an HRA. As a consequence, it would be expected that most of the genome sequence data files on the list of UUIDs returned in a response to a query for which a PTEN deletion is determined to be an HRA will have metadata attributes indicative of such a deletion.

The HRAs may be considered to be data points that are heavily weighted based on a voting scheme and a set of rules that may be continuously modified based on new information and knowledge. In this regard, an HRA may be considered to be specific to a particular query and the response to such query.

Again referring to FIGS. 25A and 25B, in a stage 2507 the transcriptor 2128 next identifies those metadata files 2142, and the metadata files stored within other networked repositories, which include at least one highly-ranked attribute and were not identified in the initial, specific response to the request received during stage 2501. For example, in the exemplary case in which the request relates to prostate cancer, such metadata files including at least one highly-ranked attribute could include those having a PTEN deletion attribute. In this particular exemplary case, all metadata files that are associated with genome sequence files and contain within the disease field the term prostate cancer will be involved in the analysis process.

In the exemplary case in which the primary subject of query received during stage 2501 was determined to be prostate cancer, at least all of the metadata files associated with individuals whom have been clinically diagnosed with prostate cancer by an oncologist will be evaluated by the transcriptor 2128. In one embodiment each such file would include the attribute “prostate cancer” within a “disease type” field of the file. However, simply because an individual is not clinically diagnosed as having prostate cancer using traditional approaches does not mean that such individual is not advancing towards this disease condition at the molecular level. As a consequence, sequence information derived from analytes produced from the tissue of such an individual may include cellular queues or biomarkers which contribute significantly to such disease condition and which therefore may be relevant to determining whether such condition exists in a given individual.

In a stage 2508, the transcriptor 2128 identifies those metadata files which are associated with a primary subject of the query received during stage 2501 (e.g., those metadata files having the attribute “prostate cancer” in the “disease type” field) but which do not include any of the HRAs determined based upon the received query request and the initial, specific response to such request. Again, in one embodiment the metadata files include the metadata files 2142 as well as the metadata files stored within other repositories networked with the Smart Repository™ data repository 2110. In this exemplary case it is assumed that when individuals have been diagnosed with a particular disease (e.g., prostate cancer), an attribute reflecting this diagnosis is included within a “disease type” or similar field in the applicable metadata file. Accordingly, those patients associated with metadata files identified during stage 2508 may be considered to be “rare variants” in the sense that such patients have been diagnosed with a particular disease condition but exhibit none of the HRAs generally associated with such condition.

In a stage 2509, the transcriptor 2128 aggregates the files identified during stages 2506, 2507 and 2508 (or the UUIDs corresponding to such files) in order to form a script of supplementary information relating to the query received during stage 2501 and the initial, specific response to the query provided during stage 2504. Once the script of supplementary information has been formed by the transcriptor 2128 it is sent to the requesting actor 2124 (stage 2510).

The above-described script of supplementary information advantageously enables the requesting actor to access potentially obscure but nonetheless relevant information that was not explicitly requested nor included within the initial, specific response to the request received during stage 2501. Such advantageous results are facilitated by the dynamic characterization of the original query and subsequent statistical correlation analysis of the various fields of the ancillary metadata associated with the genome sequence data from the patient of interest carried out in the manner described above. However, other approaches to developing such a script of supplemental information based upon an original query and/or initial query response may be apparent to those skilled in the art in view of the teachings and exemplary approaches described herein. Moreover, it should be appreciated that the schema and process disclosed in FIGS. 25-26 is purely illustrative and does not in any way restrict the scope of the present disclosure. For example, the process could be reconfigured or redesigned in light of the teachings herein to leverage the features and functionality of a Smart Repository™ data repository accessible to network users.

### Request Processing in the Biological Data Network

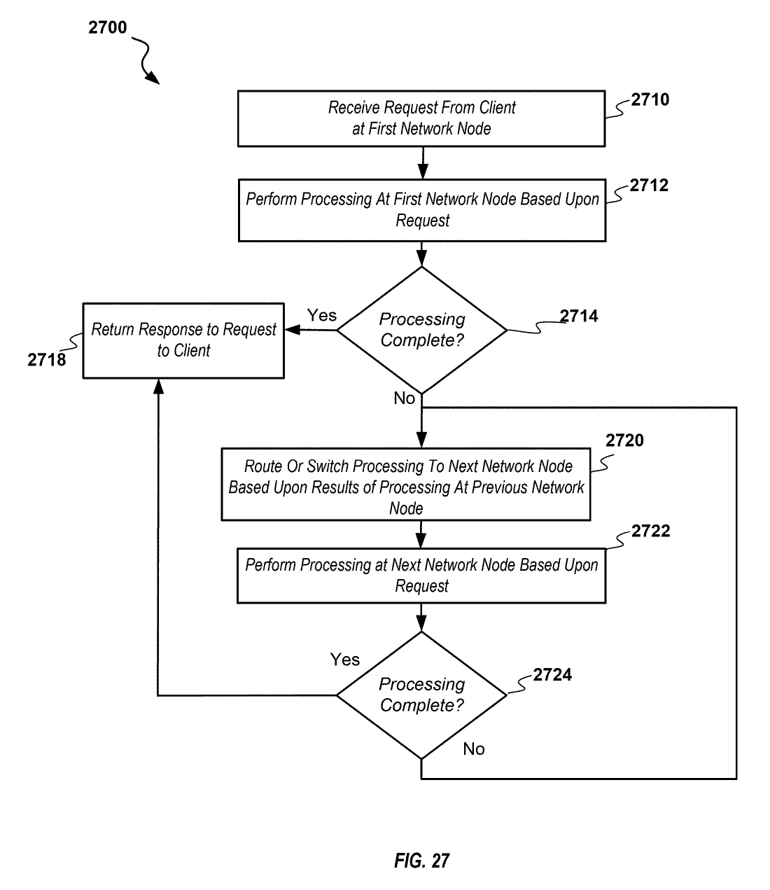

Turning now to FIG. 27, a flowchart 2700 provides an overview of an exemplary manner in which network nodes 510 of the biological data network 500 may cooperate to process a client request. In stage 2710, a request is received from a client device at a first network node 510. Based upon the request, processing is performed at the first network node based upon the request (stage 4102). In stage 2714, it is determined whether processing at the first network node is complete. If such processing is complete, then an appropriate response is returned to the client (stage 2718). If not, the results of the processing at the first network node 510 may be routed or switched to a next network node 510 selected or otherwise scheduled in accordance with the nature of such processing results (stage 2720). In a stage 2722, processing is performed at the next network node based upon the request (stage 2722). It is then determined whether processing at the next network node has been completed (stage 2724). If such processing has been completed, a response is returned to the client (stage 2718); otherwise, some or all the accumulated processing results may again be routed or switched to a next network node 510 stage 2720.

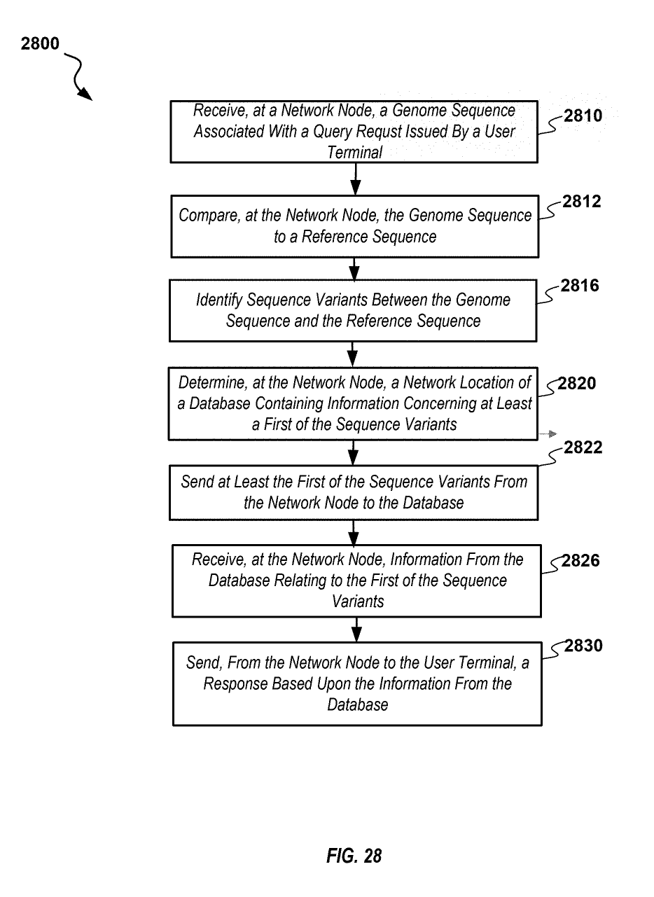

FIG. 28 is a flowchart representative of an exemplary sequence of operations involved in the identification and processing of sequence variants at a network node 510. In stage 4010, a genome sequence (e.g., a segment of the entire genome of an organism) associated with a request issued by a user terminal or other client device is received at a network node 510. The genome sequence is then compared with a reference sequence at the network node (stage 2812). Through this comparison sequence variants between the genome sequence and the reference sequence are identified (stage 2816). In a stage 2820, a network location of a database containing information concerning at least a first of the sequence variants it is determined. Next, at least the first of the sequence variants is sent from the network node to the database (stage 2822). In a stage 2826, information from the database relating to the first of the sequence variants is received at the network node (stage 2826). A response is then sent from the network node to the user terminal based upon the information from the database (stage 2830).

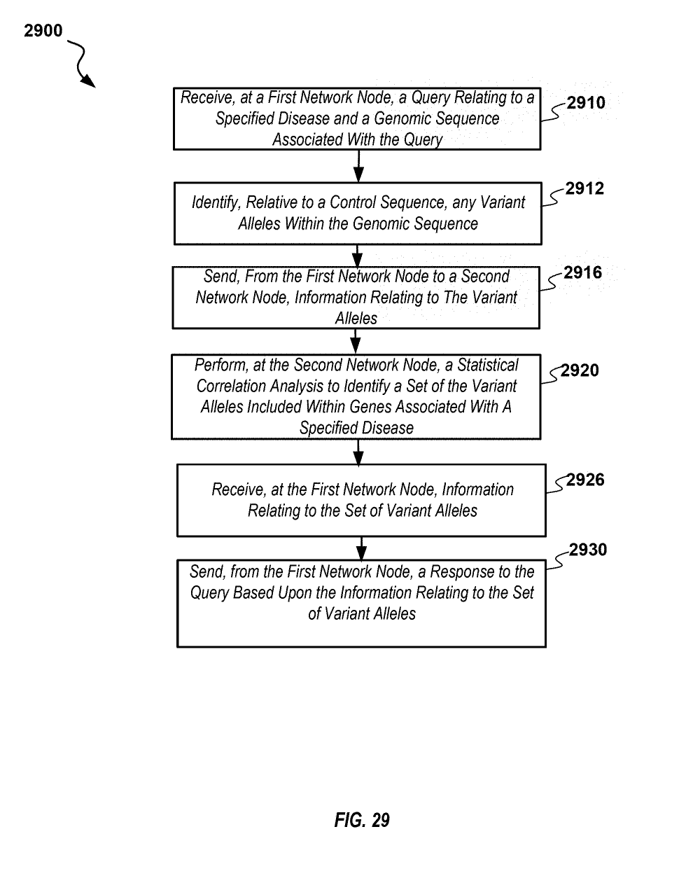

Turning now to FIG. 29, a flowchart 2900 is provided of an exemplary sequence of operations carried out by network nodes 510 of the biological data network in connection with processing of a disease-related query. In a stage 2910, a query relating to a specified disease and a genomic sequence associated with the query is received at a first network node 510 (stage 2910). Any variant alleles within the genomic sequence are then identified relative to a control sequence (stage 2912). Next, information relating to the variant alleles is sent from the first network node to a second network node (stage 2916). In a stage 2920, a statistical correlation analysis is performed at the second network node 510 in order to identify a set of the variant alleles included within genes associated with a specified disease (stage 2920). Information relating to the set of variant alleles is then received at the first network node (stage 2926). In a stage 2930, a response to the query is sent from the first network node 510 based upon the information relating to the set of variant alleles (stage 2930).

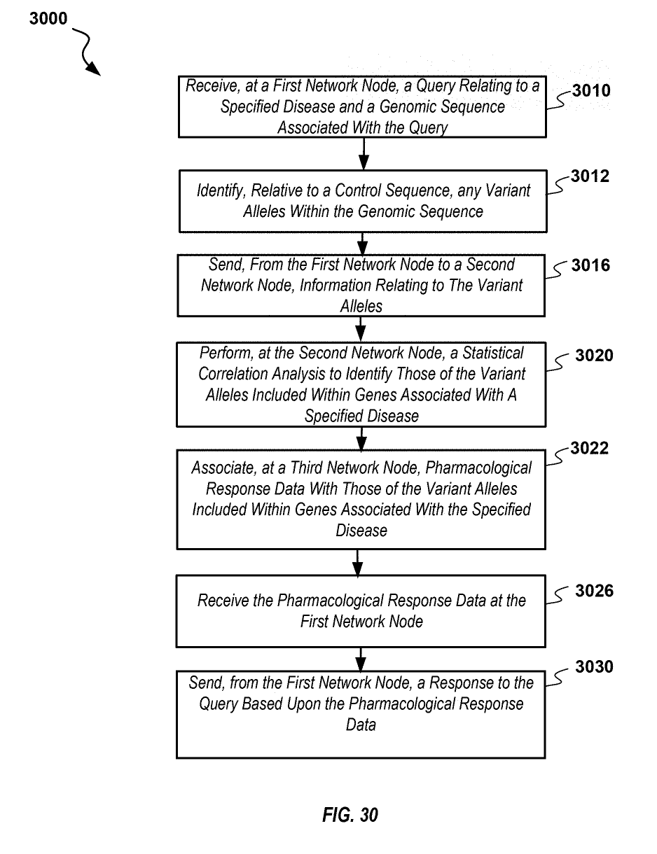

Attention is now directed to FIG. 30, which is a flowchart 3000 representative of an exemplary sequence of operations involved in providing pharmacological response data in response to a user query concerning a specified disease. In a stage 3010, a query relating to a specified disease and a genomic sequence associated with the query are received at a first network node 510. Next, any variant alleles within the genomic sequence are identified relative to a control sequence. In a stage 3016, information relating to the variant alleles is sent from the first network node 510 to a second network node. A statistical correlation analysis is then performed at the second network node in order to identify those of the variant alleles included within genes associated with a specified disease (stage 3020). At a third network node 510, processing is performed to associate pharmacological response data with those of the variant alleles included within genes associated with the specified disease (stage 3022). Such pharmacological response is sent from the third network node 510 and received at the first network node (stage 3026). A response to the query is then sent from the first network node to, for example, a client terminal based upon the pharmacological response data (stage 3030).

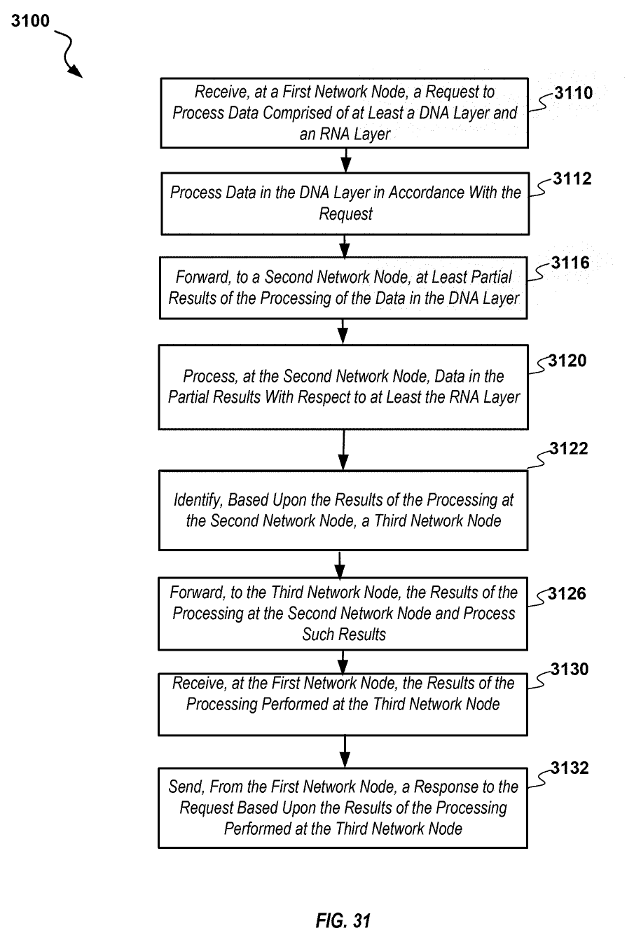

Referring now to FIG. 31, there is shown a flowchart 3100 representative of the manner in which information relating to various different layers of biologically-relevant data organized consistently with the biological data model 200 may be processed at different network nodes 510. In a stage 3110, a request to process data comprised of at least a DNA layer 210 and an RNA layer 220 is received at a first network node. Data in the DNA layer is then processed in accordance with the request (stage 3112). At least partial results of the processing of the data in the DNA layer is then forwarded to a second network node (stage 3116). Data within the partial results is then processed at the second network node with respect to at least the RNA layer (stage 3120). A third network node is then identified based upon the results of the processing at the second network node (stage 3122). The results of the processing at the second network node are then forwarded to the third network node, which then processes such results (stage 3126). The results of the processing performed at the third network node are then sent and subsequently received at the first network node (stage 3130). A response to the request is then sent from the first network node to, for example, a client terminal based upon the results of the processing performed at the third network node 510 (stage 3132).

The word “exemplary” is used herein to mean “serving as an example, instance, or illustration.” Any embodiment described herein as “exemplary” is not necessarily to be construed as preferred or advantageous over other embodiments.

In one or more exemplary embodiments, the functions, methods and processes described may be implemented in hardware, software, firmware, or any combination thereof If implemented in software, the functions may be stored on or encoded as one or more instructions or code on a computer-readable medium. Computer-readable media includes computer storage media. Storage media may be any available media that can be accessed by a computer.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

It is understood that the specific order or hierarchy of steps or stages in the processes and methods disclosed are examples of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the embodiments disclosed herein may be implemented as electronic hardware, computer software, or combinations of both.

To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, the scope of the invention includes hardware not traditionally used or thought-of having use within general purpose computing, such as graphic processing units (GPUs).

The steps or stages of a method, process or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

Certain of the disclosed methods may also be implemented using a computer-readable medium containing program instructions which, when executed by one or more processors, cause such processors to carry out operations corresponding to the disclosed methods.

An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. It is intended that the following claims and their equivalents define the scope of the disclosure.

1. A method for facilitating transfer of an electronic file over a network, the method comprising:
sending a first portion of the electronic file from a first server instance of a plurality of server instances;
sending a second portion of the electronic file from a second server instance of the plurality of server instances;
receiving, at the first server instance, information relating to the second portion of the electronic file sent by the second server instance; and
sending a third portion of the electronic file from the first server instance;
wherein the third portion is different from the second portion and wherein the first server instance and the second server instance are created in response to a request to transfer the electronic file.

2. The method of claim 1 further including encrypting the first portion of the electronic file using first encryption information and encrypting the second portion of the electronic file using second encryption information different from the first encryption information.

3. The method of claim 2 further including reading the third portion of the electronic file from the database.

4. The method of claim 1 further including providing, to the second server instance, information relating to the sending of the first portion of the electronic file.

5. The method of claim 1 further including receiving information relating to a fourth portion of the electronic file sent by a third server instance wherein the third portion is different from the fourth portion.

6. The method of claim 5 further including sending, from the first server instance, a fifth portion of the electronic file wherein the fifth portion is different from the second portion and the fourth portion.

7. The method of claim 1 wherein the first portion of the electronic file is sent to a first receiving node different from a second receiving node configured to receive the second portion of the electronic file.

8. The method of claim 1 wherein the third portion of the electronic file is sent to the first receiving node.

9. The method of claim 1 further including:
receiving information relating to corruption of the first portion of the electronic file; and
resending the first portion of the electronic file from the first server instance.

10. The method of claim 1 wherein the electronic file includes genomic information.

11. The method of claim 10 wherein the genomic information comprises information associated with a plurality of layers of a data model.

12. The method of claim 11 wherein the first portion, the second portion and the third portion of the electronic data file are each associated with a first of the plurality of layers.

13. The method of claim 11 wherein the first portion of the electronic file is associated with a first of the plurality of layers and the second portion of the electronic file is associated with a second of the plurality of layers.

14. A method for facilitating transfer of an electronic file over a network, the method comprising:
generating first encrypted file information by encrypting a first portion of the electronic file using first encryption information;
generating second encrypted file information by encrypting a second portion of the electronic file using second encryption information different from the first encryption information;
generating third encrypted file information by encrypting a third portion of the electronic file using the first encryption information;
sending, from a first server instance, a data stream including the first encrypted file information and the third encrypted file information; and
sending the second encrypted file information from a second sever instance.

15. The method of claim 14 wherein the first encryption information includes a first encryption key and the second encryption information includes a second encryption key.

16. The method of claim 14 wherein the electronic file includes genomic information.

17. The method of claim 16 wherein the genomic information comprises information associated with a plurality of layers of a data model.

18. A method for facilitating transfer of an electronic file over a network, the method comprising:
receiving, from a first receiving server instance, a first portion of an electronic file sent by a first sending node;
receiving, from a second receiving server instance, a second portion of the electronic file sent by a second sending node; and
receiving, from the first receiving server instance, a third portion of the electronic file sent by the first sending node;
wherein the first receiving server instance and the second receiving server instance are included within a plurality of server instances created to transfer the electronic file.

19. The method of claim 18 wherein the first portion of the electronic file is encrypted using first encryption information and the second portion of the electronic file is encrypted using second encryption information, the first receiving server instance and the second receiving server being located within a user system.


SEQUENCE LISTING (32 sequences)

SEQ ID NO: 1 - DNA, 20 bp, Unknown
  Example sequence fragment
acgccgtaacgggtaattca

SEQ ID NO: 2 - DNA, 30 bp, Unknown
  Example nucleotide sequence
ccggtccaggggacgcgaccaaaaagccca

SEQ ID NO: 3 - DNA, 30 bp, Unknown
  Example nucleotide sequence
ccagtccaggaaaaacgacgcgaccgccca

SEQ ID NO: 4 - DNA, 20 bp, Unknown
  Example nucleotide sequence
aagccgtaacgggtaattcg

SEQ ID NO: 5 - DNA, 20 bp, Unknown
  Example nucleotide sequence
acgacgtaacgggtaattcg

SEQ ID NO: 6 - DNA, 20 bp, Unknown
  Example nucleotide sequence
acgacgtatcgggtaattca

SEQ ID NO: 7 - DNA, 20 bp, Unknown
  Example nucleotide sequence
acgacgtatcgggtaataca

SEQ ID NO: 8 - DNA, 20 bp, Unknown
  Example nucleotide sequence
acgacgtaacgggtaattca

SEQ ID NO: 9 - DNA, 30 bp, Unknown
  Example nucleotide sequence
gggggggggggggggggggggggggggggg

SEQ ID NO: 10 - DNA, 30 bp, Unknown
  Example nucleotide sequence
ggggggggggggggtggggggggggggggg

SEQ ID NO: 11 - DNA, 3000 bp, Unknown
  Example nucleotide sequence
  misc_feature (21)..(2990): May be a known sequence from a particular strain of influenza virus
ggggggggggggggtgggggnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnngggggggggg

SEQ ID NO: 12 - DNA, 612 bp, Homo sapiens
cggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcggcgg

SEQ ID NO: 13 - DNA, 15 bp, Unknown
  Example nucleotide sequence
acgtagggcattgca

SEQ ID NO: 14 - DNA, 14 bp, Unknown
  Example nucleotide sequence
acctaggcattgca

SEQ ID NO: 15 - protein, 231 aa, Homo sapiens
MEPQVTLNVTFKNEIQSFLVSDPENTTWADIEAMVKVSFDLNTIQIKYLDEENEEVSINSQGEYEEALKMAVKQGNQLQMQVHEGHHVVDEAPPPVVGAKRLAARAGKKPLAHYSSLVRVLGSDMKTPEDPAVQSFPLVPCDTDQPQDKPPDWFTSYLETFREQVVNETVEKLEQKLHEKLVLQNPSLGSCPSEVSMPTSEETLFLPENQFSWHIACNNCQRRIVGVRYQC

SEQ ID NO: 16 - protein, 112 aa, Homo sapiens
MWKGGRSHPFLPCSSRRAGSGGQLDSILPHQSPAWGPWGCKDLSSGVPSFLTSSILWKSAVFAEDNGLKIHLCSYKRDDLVLFYDCTSFVLTFGPSPWFLTQGFLNPLEFSA

SEQ ID NO: 17 - protein, 160 aa, Homo sapiens
MDLSALRVEEVQNVINAMQKILECPICLELIKEPVSTKCDHIFCKFCMLKLLNQKKGPSQCPLCKNDITKRSLQESTRFSQLVEELLKIICAFQLDTGLEYANSYNFAKKENNSPEHLKDEVSIIQSMGYRNRAKRLLQSEPENPSLQETSLSVQLSNLG

SEQ ID NO: 18 - protein, 311 aa, Homo sapiens
LPRQDLEGTPYLESGISLFSDDPESDPSEDRAPESARVGNIPSSTSALKVPQLKVAESAQSPAAAHTTDTAGYNAMEESVSREKPELTASTERVNKRMSMVVSGLTPEEFMLVYKFARKHHITLTNLITEETTHVVMKTDAEFVCERTLKYFLGIAGGKWVVSYFWVTQSIKERKMLNEHDFEVRGDVVNGRNHQGPKRARESQDRKIFRGLEICCYGPFTNMPTDQLEWMVQLCGASVVKELSSFTLGTGVHPIVVVQPDAWTEDNGFHAIGQMCEAPVVTREWVLDSVALYQCQELDTYLIPQIPHSHY

SEQ ID NO: 19 - DNA, 120 bp, Homo sapiens
gatctaattttgtccgttcaggggaacataattttgcctggctttgctaatccaaatgcacatttgaacacaacaatctgaatagttacaacatacaaagcatgtgggtgaagagtagct

SEQ ID NO: 20 - DNA, 162 bp, Homo sapiens
tacatatctctgaccctttgtccccatccaatctccccagaccttccatcccaagcccaaacacaaccttacctgctgctccttttcaggcaccctggccaccaaatataggaacccataaattttgctcatactctatgttctactaggcaagtcctgatc

SEQ ID NO: 21 - DNA, 195 bp, Unknown
  Example nucleotide sequence
gacttacggcaaatgtgtgccaaagaggcggcacataaggattttaaaaaggcagttggtgccttttctgtaacttatgatccagaaaattatcagcttgtcattttgtccatcaatgaagtcacctcaaagcgagcacatatgctgattgacatccactttcggagtctgcgcactaagttgtctctgataatg

SEQ ID NO: 22 - DNA, 34 bp, Unknown
  Example nucleotide sequence
acgggagcatcatcatccttacttacttccaagg

SEQ ID NO: 23 - DNA, 32 bp, Unknown
  Example nucleotide sequence
acgggcgcatcatcaccttacttacttccaag

SEQ ID NO: 24 - DNA, 33 bp, Unknown
  Example nucleotide sequence
acgggcgcatcatcatccttacttacttccaag

SEQ ID NO: 25 - DNA, 35 bp, Unknown
  Example nucleotide sequence
acgggcgcatcatcatccttacccttacttccaag

SEQ ID NO: 26 - DNA, 33 bp, Unknown
  Example nucleotide sequence
acgggcgcatcatcatccttcttccaagactta

SEQ ID NO: 27 - DNA, 17 bp, Unknown
  Example nucleotide sequence
ggaggctagttagtata

SEQ ID NO: 28 - protein, 14 aa, Unknown
  Example amino acid sequence
MDLSALRVEVAMQE

SEQ ID NO: 29 - protein, 16 aa, Unknown
  Example amino acid sequence
LPRQDLESGISLFPES

SEQ ID NO: 30 - RNA, 12 nt, Unknown
  Example ribonucleotide sequence
gauaccucaguc

SEQ ID NO: 31 - DNA, 12 bp, Unknown
  Example nucleotide sequence
gatacctcagtc

SEQ ID NO: 32 - RNA, 17 nt, Unknown
  Example ribonucleotide sequence
ggaggcuaguuaguaua